(19) United States
(12) Patent Application Publication
(10) Pub. No.: US 2023/0058712 A1
(43) Pub. Date: Feb. 23, 2023

(54) Time-Based Predictive Machine Control

(71) Applicant: Creator, Inc., San Francisco, CA (US)

(72) Inventors: James Riley, San Francisco, CA (US); Jeff C. Jensen, San Francisco, CA (US); Alexandros Vardakostas, San Francisco, CA (US); Steven Frehn, San Francisco, CA (US)

(21) Appl. No.: 17/937,436

(22) Filed: Sep. 30, 2022

Related U.S. Application Data
(60) Provisional application No. 63/233,721, filed on Aug. 16, 2021.
(60) Provisional application No. 63/294,837, filed on Dec. 29, 2021.

(51) Int. Cl. A47J 36/32; G05B 13/04

(52) U.S. Cl. CPC A47J 36/32; G05B 13/048

(57) ABSTRACT

A control system for a culinary instrument includes an order management module configured to generate parameters for a user interface. The control system includes an order prioritization module configured to assign priorities to orders based on a set of prioritization rules, which establish a sequence of the set of orders. The control system includes an order wait time module configured to estimate wait times for the orders. The order wait time module estimates wait times for the orders based on a current status of the culinary instrument and a model of predicted interruptions of the culinary instrument. The order management module is configured to transform the user interface by the parameters in response to the estimated wait times. The control system includes an instrument control module configured to control the culinary instrument to prepare a food item specified by an order specified as next by the sequence.

### CROSS-REFERENCE TO RELATED APPLICATIONS

This application claims the benefit of U.S. Provisional Application No. 63/294,837 filed Dec. 29, 2021 and U.S. Provisional Application No. 63/233,721 filed Aug. 16, 2021. The entire disclosures of the above applications are incorporated by reference.

### FIELD

The present disclosure relates to computer control of robotic apparatuses and more particularly to time-based robotic control of culinary instruments for real-time food preparation.

### BACKGROUND

In automated food production environments, the exact wait time for any particular item may not be important. Instead, overall throughput is often the key metric. This is because automation has traditionally been performed in a non-real-time environment, with food being prepared at a central facility, packaged, and then distributed. However, as automated production moves closer to the customer—arriving at real time order preparation in direct response to a specific customer order—the specific wait time for each order becomes more important and estimating that time accurately also increases in importance.

While intuitive, subjective estimation of preparation times has long been performed by front-of-house and back-of-house staff in restaurants, robotic automation of food preparation creates additional complexities and creates opportunities for solutions, both in estimation and in control. Fine-grained control and instrumentation offers possibilities for increased accuracy of estimation and closed-loop dynamic control.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A control system for a culinary instrument includes an order management module, an order prioritization module, an order wait time module, and an instrument control module. The order management module is configured to generate parameters for a user interface. The order prioritization module is configured to assign priorities to a set of orders in an order database based on a set of prioritization rules. The assigned priorities establish a sequence of the set of orders. The order wait time module is configured to estimate wait times for the set of orders. The order wait time module estimates wait times for each of the set of orders based on a current status of the culinary instrument and a model of predicted interruptions of the culinary instrument. The order management module is configured to transform the user interface by modifying at least one of the parameters in response to the estimated wait times. The instrument control module is configured to control the culinary instrument to prepare a food item specified by an order of the set of orders specified as next by the sequence.

In other features, the control system is configured to control a plurality of culinary instruments including the culinary instrument. In other features, the instrument control module is configured to, in response to availability of a first instrument of the plurality of culinary instruments, selectively control the first instrument to prepare the food item specified by the next order. In other features, the instrument control module is configured to, in response to availability of a first instrument of the plurality of culinary instruments: identify ingredients necessary to prepare the food item specified by the next order, identify in-stock ingredients present at the first instrument, and, in response to the necessary ingredients being a subset of the in-stock ingredients, control the first instrument to prepare the food item specified by the next order.

In other features, the instrument control module is configured to, in response to availability of the culinary instrument, control the culinary instrument to prepare the food item specified by the next order. In other features, the culinary instrument includes a plurality of subsystems. Preparing the food item specified by the next order begins with an initial subsystem of the plurality of subsystems. Availability of the culinary instrument is indicated by availability of the initial subsystem. In other features, availability of the initial subsystem is indicated by a container of a food item for a prior order moving away from the initial subsystem. In other features, availability of the initial subsystem is indicated by completion of work performed by the initial subsystem on a food item for a prior order.

In other features, transformation of the user interface includes displaying a time indicating at least one of the estimated wait time for the next order and an estimated completion time for the next order. The estimated completion time is based on a sum of a current time and the estimated wait time. In other features, transformation of the user interface includes displaying a progress bar. A length of the progress bar increases monotonically as the estimated wait time for the next order decreases.

In other features, the order prioritization module is configured to determine the assigned priorities based on, for each order of the set of orders, a timestamp indicating when the order was placed and a selective adjustment to the timestamp. In other features, the order prioritization module is configured to determine the selective adjustment for each order of the set of orders by determining a set of rules applicable to the order and summing an adjustment value for each rule of the set of rules.

In other features, the set of rules is selected from a plurality of rules. Each rule of the plurality of rules is associated with a respective adjustment value. In other features, the set of rules is selected from a plurality of rules. Each rule of the plurality of rules specifies one of a respective adjustment value and an expression to calculate the respective adjustment value. In other features, the order wait time module is configured to estimate the wait times based on performance data for staff members associated with the culinary instrument.

In other features, the control system includes a data store configured to store performance data for each member of a plurality of staff members. In other features, the order wait time module is configured to estimate the wait times based on performance data for ones of the staff members staff presently working. In other features, the model of predicted interruptions of the culinary instrument outputs (i) a likelihood of interruption of the culinary instrument and (ii) an estimated length of the interruption.

### BRIEF DESCRIPTION OF THE DRAWINGS

Further areas of applicability of the present disclosure will become apparent from the detailed description, the claims, and the drawings. The detailed description and specific examples are intended for purposes of illustration only and are not intended to limit the scope of the disclosure.

The present disclosure will become more fully understood from the detailed description and the accompanying drawings.

FIG. 1 is a functional block diagram of an example establishment at which a culinary instrument is installed.

FIG. 2 is a schematic representation of an example implementation of the culinary instrument of FIG. 1.

FIG. 3 is a functional block diagram of an example ordering system that interfaces with mobile devices to place food orders and with the culinary instrument to prepare food.

FIGS. 4A and 4B together form a flowchart of example processing and preparation of a single order according to various implementations of the present disclosure.

FIG. 5 is a flowchart of example operation of selecting a culinary instrument for preparation of a particular order.

FIG. 6 is a flowchart depicting example operation of a response to a culinary instrument becoming unavailable.

FIG. 7 is a flowchart of example operation in queueing of a new order.

FIG. 8 is a flowchart of example culinary instrument control to prepare an order.

FIG. 9 is a functional block diagram of an example implementation of a simulation system according to the principles of the present disclosure.

FIG. 10 is a flowchart of example simulation operation according to the principles of the present disclosure.

FIG. 11 is a flowchart of example coordination operation between a local order and a remote actor.

FIGS. 12A-12C collectively are a flowchart of example determination of local and remote estimates to align when coordinating an order.

FIG. 13 is a flowchart of example coordination operation between a local order and a delivery vehicle.

In the drawings, reference numbers may be reused to identify similar and/or identical elements.

### DETAILED DESCRIPTION

### Introduction

In a real-time food production environment, the term real-time means that food is prepared according to specific customer orders for provision to those customers to satisfy a current desire for food, rather than preparing standard or even customized food items ahead of time for eventual consumption. In a real-time environment, therefore, the amount of time a customer needs to wait is a critical parameter. Minimizing this time increases convenience for the customer, decreases the time that the customer remains hungry, and directly influences a customer's perception of the ordering experience. In fact, in terms of customer perception, a delay in food production may outweigh any gain in quality of the food. Therefore, correctly modeling waiting times to minimize the average wait time as well as the longest wait time is critical.

Notably, longer wait times may be acceptable when they are clearly communicated to the customer and remain consistent, without unexplained variation. As a result, accurate estimation of wait times early in the food preparation process is critical. Providing an inaccurate estimate that then fluctuates over time may be worse than no estimate at all. Instead, an accurate estimate allows the customer to appropriately plan.

For example, the customer may perform an activity, such as going to the bathroom, making a call, etc., based on the estimate. If the estimate proved to be too short, the customer may be unavailable when the order is prepared, which may lead to the customer's frustration and a potential decrease in the freshness of the food (for example, a hot food item may have cooled). On the other hand, the customer may have cut short another activity in order to be ready for food completion, and will be frustrated if the estimate turns out to have been too short.

In various implementations, the interface between the restaurant and the customer may include a delivery service operated by the restaurant or by a third party. For greatest efficiency and food freshness, the delivery service would have a delivery vehicle available at the restaurant at the exact moment that the order is completed. For a delivery service, which operates with finite resources, delivery vehicles cannot simply wait at the restaurant indefinitely. Instead, arrival of the delivery vehicle should be closely timed to completion of the order. This requires accurate estimation of wait time.

In addition to accurate estimation of wait time, prioritization rules can be used to reprioritize orders to achieve previously indicated wait times in order to accommodate changing schedules. For example, if a delivery vehicle will be delayed, that order may be moved back in the queue, allowing other orders to be prepared earlier. As another example among many, an order that was prepared incorrectly may be re-ordered (also known as re-fired) and the re-order is given a high priority so that the correct order can be provided to the customer as soon as possible.

As just one more example, prioritization may also permit clustering, where multiple orders that are delivered to a single customer or associated group of customers or a single delivery vehicle may be clustered for completion in consecutive timeslots so that the orders are all prepared as close to each other as possible. This maximizes the average freshness of each order in the cluster and avoidance problems where one customer in a group receives their order well in advance of others. In various implementations, this clustering may happen naturally if the orders are all submitted at the same time or if they are submitted as an aggregate order and then separated into individual orders for preparation.

Wait times may be communicated via an application programming interface (API) that interfaces with a third-party ordering system or delivery system. This may allow for coordination of delivery vehicles and for updating of third-party user interfaces. In various implementations, access to the API may be offered on a paid subscription basis or on a transactional basis, where a small amount is paid for each order where a wait time communicated. Payment for real-time data may also be used with customers. For example, price segmentation may allow some users to access wait times (or even real-time updated wait times), while users at a lower price point receive only an initial wait time or a generic wait time.

In various implementations, an ordering application may be installed on or accessed by (such as through a web interface) a mobile device of the customer. The wait time may then be presented to the user on a user interface of the mobile device by transforming the user interface according to the wait time. In various implementations, and in various screens of the application, the wait time may be rendered differently. For example, the wait time may be rendered as a countdown timer that updates once per second, as an integer number of minutes that updates once per minute, or as a progress bar that increases towards completion.

In various implementations, a progress bar may be linear or may be arranged in different shapes such as in an arc. Other graphical representations are possible, such as rendering a line drawing of the food item as a progress bar, with the food item filling in either with a solid color or transitioning from grayscale to full-color as the item nears completion. For example, when a burger is being prepared, a line drawing of the burger may begin in grayscale and a visible or invisible line may move from the bottom of the burger to the top of the burger, where areas of the burger below the line are rendered in color and areas above the line are rendered in grayscale. The line may begin moving up the burger as the burger order advances in the queue or may wait to begin moving until a culinary instrument is actually preparing the burger. In various implementations, more detailed status displays may be used, such as showing each ingredient that is being added to the order. This may be an estimate or may be based on real-time data provided by the culinary instrument.

While an accurate time estimate produced at the beginning of the order process is the goal, the wait time may need to be adjusted, such as due to an unexpected interruption of the culinary instrument, whether by a mechanical complication or some other delay, such as a lack of stock of some ingredient or a human delay. When a change in wait time is identified, this change may be immediately communicated or the change may be gradually phased in. In the ideal situation, the new estimate will be accurate once the new situation is taken into account, and therefore should be immediately communicated to the customer.

A change in wait time that is greater than a certain amount (which may be measured as a percentage or as an absolute number of minutes) may result in a further transformation of the user interface, such as to highlight to the customer that a change has occurred so that the customer can plan accordingly. In various implementations, a message may indicate the reason for the change in wait time, and this explanation may be used to apologize to the customer and provide context for the change so that the customer is not frustrated by unexplained delays.

In addition to transforming a user interface, notifications may be generated on the customer's device, which may take the form of banner notifications from an application, text messages, etc. In various implementations, a customer may place an order by phone. The wait time may then be communicated to the customer at the end of the call and substantial changes in wait time may be communicated to the customer by follow-up calls.

Instead of or in addition to ordering applications installed on or accessible by user devices, a restaurant may have ordering terminals, which may take the form of phones, tablets, stationary touchscreens, point-of-sale machines, etc. These screens may be used to display wait times. In various implementations, staff at the restaurant, such as a concierge or manager, may have an interface that displays wait times, which can be used to answer customer questions and address potential customer concerns. For example, the manager may have special notifications of longer-than-usual wait times or wait times that have changed by more than a threshold amount. The manager may manually address these, such as by speaking with the customer.

In various implementations, some customer service interactions may be automated. For example, manager input may not be needed when an actual time increases beyond the initial wait time estimate by more than a threshold. For example, in these instances, the system may automatically issue a refund to the customer. In various implementations, the threshold may be defined as a percentage (such as 40%) of the initial wait time estimate. In various implementations, the threshold may be bounded by an upper bound of a defined number of minutes (such as 10) regardless of how large the initial wait time estimate was.

Additionally or alternatively, a refund may automatically be issued when the actual wait time exceeds a threshold, regardless of what the initial wait time estimate was. In various implementations, a refund may be tiered based on how long the actual wait time exceeds the initial wait time, a threshold above the initial wait time, or an absolute wait time threshold. For example, the refund may be scaled linearly or logarithmically from 0% to 100% as the actual wait time increases from a lower threshold to an upper threshold. For example only, the lower threshold may be equal to the initial wait time plus a percentage (which may, in some implementations, 0%). The upper threshold may be the initial wait time plus another percentage (such as 40%, 60%, or 80%), and the upper threshold may be capped at a ceiling value regardless of how large the initial wait time was. In various implementations, the refund may be replaced with another form of alternative compensation, such as gift cards, higher priority for future orders, etc.

When the customer is remote—for a ghost kitchen (a restaurant with no direct customer interaction that relies on delivery), this would be all customers—the manager may reach out to the customer via phone, text, or an application. In various implementations, the manager or concierge may be able to manually reprioritize or re-sequence orders to accommodate customer requirements, such as a customer who needs to return to work immediately and cannot wait longer.

In various implementations, a graphical display at the restaurant may provide order tracking indications for some or all current orders. For example, the display may take the form of a leaderboard on a large screen visible to customers waiting for orders. The leaderboard may announce (for example, by first name or order number) the progress of the order, which may include a wait time. In various implementations, individual wait times are displayed next to each order. In other implementations, the orders are shown in sequence and wait times are displayed based on the location in the queue. For example, indications of 0, 5, 10, or 15 minutes may be displayed on a vertical axis while a sequence of orders is displayed in a vertical list. Then, the customer can estimate their wait time based on the location of their order in the queue.

Providing accurate wait time estimates that minimally fluctuate over time is helpful for real-time control of one or more culinary instruments. These estimates may also be used in simulations. For example, a simulation may model the arrival of orders during a meal service, such as a lunch service, and the estimated wait times can be simulated to gather data on the customer experience. For example, the data may reveal the longest wait time for customers at the peak of a rush of orders and may show how the average wait time varies throughout the period of service.

Simulations may be based on historical order flow and may also be used to estimate the response of the restaurant to unexpected surges or expected surges that have not been experienced previously. For example, the introduction of a new promotion or the involvement of a new delivery service may be expected to result in a spike of orders, and simulation can be used to assess various performance parameters that may be experienced during such an event.

Simulation also allows for hypotheticals. One use case is adjusting the culinary instrument's takt time, production time, and/or reliability, and evaluating the change in wait times. Another use case is using simulation data to determine the effect on wait times of adding one or more additional culinary instruments to a location or region. This data can then be used in a cost-benefit analysis.

Yet another use case for the simulation may allow for the development of prioritization rules that don't lead to any specific order having an unduly long wait time. For example, a prioritization rule that preferences in-person orders over remote orders may result in long wait times for the remote orders during a time of peak order flow. These sorts of issues can be assessed and corrected during simulations. In various implementations, simulations may be combined with machine learning to develop algorithms to optimize for certain business metrics. For example, a genetic algorithm could iterate over different rules and schemas by running many simulations and varying the parameters.

In addition, the response of the system to various inputs can be simulated. For example, the number of staff available to service the culinary instrument can be assessed. In addition, the performance of individual staff members can be assessed. For example, if there is a staff member who has one or more performance metrics that appear suboptimal, a simulation can determine whether any changes to those performance metrics will affect wait time performance and to what extent.

These simulations may allow an operator to assign different staff to different functions and assess whether certain performance deficiencies are acceptable or whether they have a significant impact on wait time. Further, hypotheticals involving culinary instrument availability may be run. For example, if the culinary instrument becomes unavailable due to lack of an ingredient, various hypotheticals can be tested. For example, if having another container of a particular ingredient always standing by fully-prepared reduces the length of an interruption, preparing the additional container may be prioritized highly in the actual restaurant.

As another example, reducing the likelihood of an interruption or pause by increasing an amount of preventative maintenance can be measured. For example, a labor-intensive process can be performed once a week or more frequently, such as once a day. If the process is performed once per day and the likelihood of an interruption decreases by a measurable amount, that amount can be used in a simulation to determine the return on investment for that process. Even further, experiments on the culinary instrument can be performed over time and fed into the simulation. For example, a more expensive actuator, sensor, surface, etc. may be tested on one or more culinary instruments. If the more expensive element leads to shorter or fewer interruptions, a simulation can determine how that will affect order times, which can be used in a cost-benefit analysis.

As described in more detail below, wait time estimates are calculated based on current status of the one or more culinary instruments fulfilling orders. The wait times may also be based on models of machine performance, including estimates of how likely certain interruptions are to occur and estimates of how long the interruptions will last.

The wait time estimates may also be based on staff performance, which may be an average model or may be specific to teams of staff members or even to specific staff members currently working. In various implementations, performance metrics may include times to service various causes of interruption, such as a mechanical stoppage of a culinary instrument or an outage of an ingredient. The staff performance parameters may also include delays (determined empirically and/or by estimation), which may result from a shift change occurring while an order is in the queue to be produced or actually being created on a culinary instrument.

In various implementations, the machine performance data and staff performance data may be used in conjunction. For example, the machine performance data may provide estimates of how likely an interruption is to occur while the staff performance data provides an estimate of how long it will take to address the interruption. In some cases, the estimate of an interruption may be based on staff performance. For example, machine interruptions based on an outage of an ingredient may be adjusted depending on the staff currently operating the culinary instrument.

The estimated wait times may depend on prioritization of orders. As described in more detail below, prioritization may include giving higher priority to re-orders resulting from customer dissatisfaction. Priorities may also be adjusted to accelerate food items that will be provided to a delivery vehicle that is arriving sooner than the food would otherwise be ready.

In various implementations, modular programming principles may be applied to separate prioritization from wait time estimation. For example, prioritization may be used to set the sequence of orders in the queue. Then, once the orders are in a particular sequence, the wait time estimates are determined simply based on the order's position in the sequence, the prioritization having been accounted for by the order's positioning in the sequence.

In various implementations, multiple culinary instruments may be available some or all of the time to prepare orders. As described below, the orders may be assigned to one of the culinary instruments at the time the order is placed. In other implementations, the order may be prepared by whichever culinary instrument is ready when the order reaches the front of the queue. If the order is pre-assigned, interruptions to one of the culinary instruments may require the orders to be re-assigned and re-sequenced to avoid disadvantaging orders that were pre-assigned to the interrupted culinary instrument. In various implementations, this re-assigning and/or re-sequencing may be performed only if the interruption is expected to last longer than a threshold (or when an interruption that is expected to be quick surpasses the same or a different threshold).

### Block Diagrams

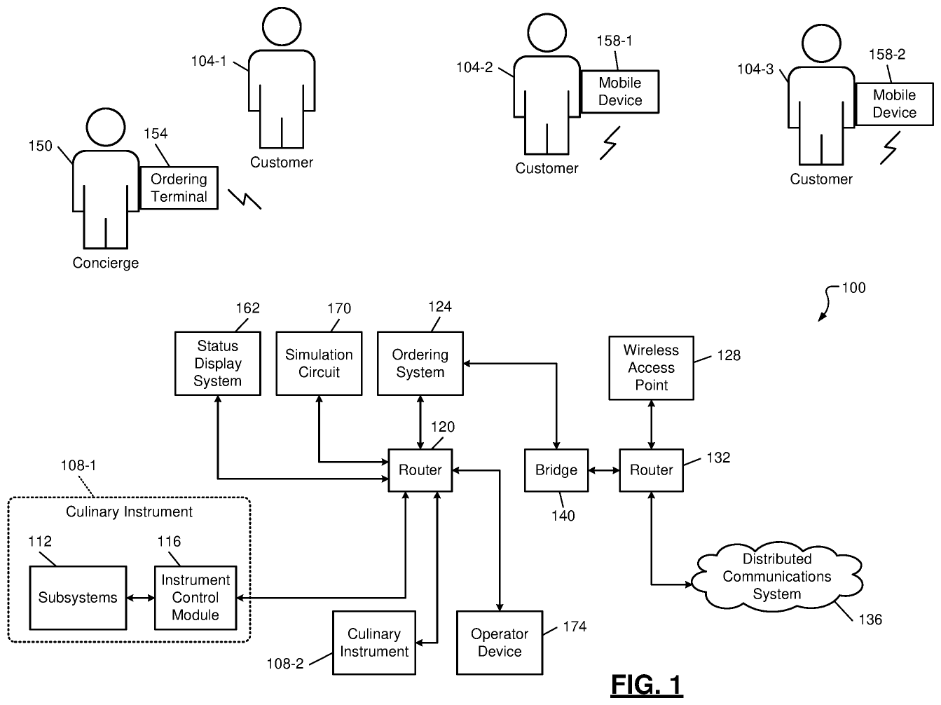

In FIG. 1, customers 104-1, 104-2, and 104-3 are placing orders with an establishment 100 that includes a culinary instrument 108-1. For example, the culinary instrument 108-1 may be configured to create a food item, such as sandwiches (for example, hamburgers), bowls, and/or burritos. While the following discussion is in the context of hamburgers, some or all of the subsystems may be applicable to other types of food item.

Subsystems 112 of the culinary instrument 108-1 may include, for example, a subsystem that dispenses a container, a subsystem that slices, butters, and toasts hamburger buns, a subsystem that dispenses toppings, such as vegetables and/or cheese, a subsystem that dispenses liquid sauces, a subsystem that dispenses powdered seasonings, a subsystem that grinds and cooks meat, a subsystem that heats the food, such as to melt cheese, etc. The culinary instrument may also include a conveyor subsystem to transport food items between other subsystems.

Subsystems 112 are coordinated by an instrument control module 116. A networking router 120 permits the instrument control module 116 to communicate with an ordering system 124. In various establishments, multiple culinary instruments may be present. As an example only, a second culinary instrument 108-2 is shown in FIG. 1. A wireless access point 128 may provide wireless Internet access to customers of the establishment 100. A router 132 connects the wireless access point 128 to a distributed communications system 136, which may include the Internet.

The ordering system 124 may receive orders from the distributed communications system 136 via a bridge 140, which may bridge between the ordering system 124 on an internal network and the router 132 on an external network. Orders may also arrive in the ordering system 124 via the wireless access point 128. In various implementations, a second internal wireless network may be used to allow employee devices to communicate with the ordering system 124 without traversing the bridge 140. For example, a concierge 150 may assist customers, such as the customer 104-1, with placing orders using an ordering terminal 154.

The ordering terminal 154 may wirelessly communicate with the wireless access point 128 or, because the ordering terminal 154 is owned by the establishment 100, with a wireless access point (not shown) that communicates with the ordering system 124 without traversing the bridge 140. As an example only, the ordering terminal 154 may be a kiosk implemented with a Windows operating system computer, a MacOS operating system computer, or an iOS operating system tablet. The customer 104-2 may place an order using a mobile device 158-1, such as an iOS operating system smartphone. Similarly, the customer 104-3 may place an order using a mobile device 158-2. One or both of the mobile devices 158 may be present in the establishment 100 and use the wireless access point 128 to obtain Internet access. In other implementations, one or both of the mobile devices 158 may connect to the distributed communications system 136 via another path, such as a different wireless local area network or a cellular network.

The orders are received and managed by the ordering system 124. In various implementations, the ordering system 124 may assign an order to either the culinary instrument 108-1 or the second culinary instrument 108-2 depending on availability of ingredients and timing. In various implementations, a remote server may assign orders originating outside of the establishment 100 to a selected establishment that can provide a customer's precise order. Once the order has been assigned to the establishment 100, the ordering system 124 may then decide which of the culinary instruments 108 will receive the order. A status display system 162 includes a visual display, such as a liquid crystal display (LCD) screen, and a control module to drive the display as described in more detail below.

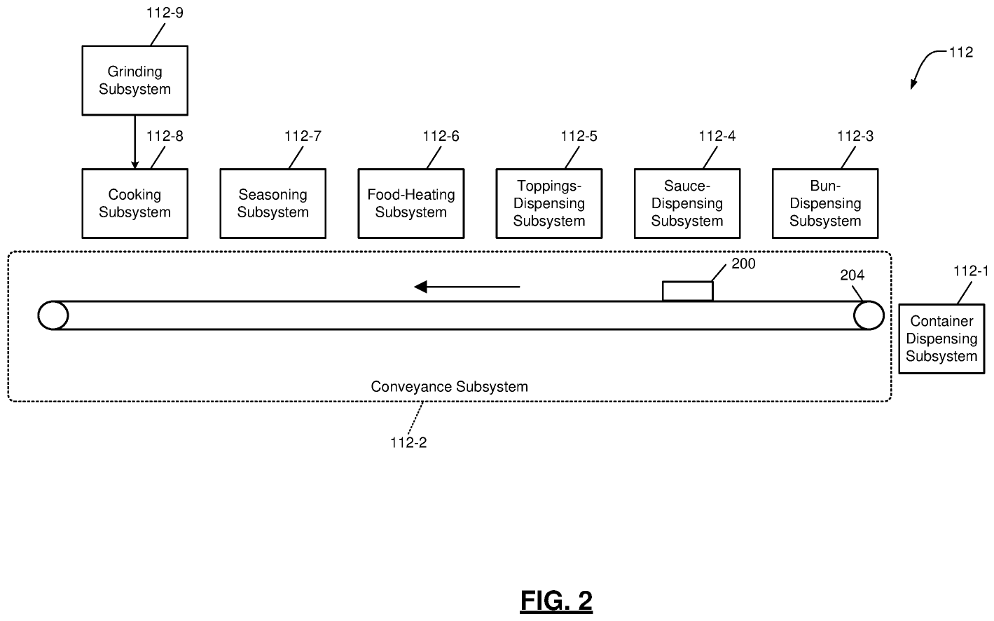

In FIG. 2, one example implementation of the culinary instrument 108-1 is shown in a configuration for creation of sandwiches, such as hamburgers. Other implementations of the culinary instrument 108-1 may include different or additional subsystems, and may be configured differently (including by changing subsystem order) to prepare different types of meals, such as bowls, burritos, etc.

In this implementation, the culinary instrument 108-1 includes a container-dispensing subsystem 112-1 that places a container 200, such as a clamshell box, on a conveyance subsystem 112-2. Although a single container 200 is shown on the conveyance subsystem 112-2, at various times a container may be present at all or a portion of the subsystems 112. Some or all of the subsystems 112 may be configured to operate concurrently.

A bun-dispensing subsystem 112-3 slices, optionally toasts, and optionally butters halves of a bun, then dispenses the bun halves in the container 200. A sauce-dispensing subsystem 112-4 dispenses sauce on one or both of the bun halves. A toppings-dispensing subsystem 112-5 prepares toppings, such as by slicing or grating, and dispenses the toppings on one or both of the bun halves. In various implementations, the toppings-dispensing subsystem 112-5 grates cheese and dispenses it onto one or both of the bun halves.

A food-heating subsystem 112-6 optionally heats the cheese to at least partially melt the cheese. A seasonings subsystem 112-7 dispenses seasonings onto one or both of the bun halves. A grinding subsystem 112-8 grinds a protein, such as meat, and forms a patty. A cooking subsystem 112-9 cooks the patty and deposits the cooked patty onto one of the bun halves.

The conveyance subsystem 112-2 may be configured to transport containers continuously or intermittently. The conveyance subsystem 112-2 may include a conveyor belt 204. In various implementations, the conveyance subsystem 112-2 includes multiple stations, such as one station per subsystem 112, that may operate independently of other stations, such as to advance the container 200 from one subsystem to the next while keeping one or more other containers stationary.

Multiple stations may be created by segmenting the conveyor belt 204 into multiple belts in series. In various implementations, each of the belts may be replaced by a series of rotating shafts, which may have fingers that advance the container 200. In various implementations, the conveyance subsystem 112-2 may include a robotic arm—for example, one that slides along a track or rail, or one that has additional degrees of freedom of movement. In various implementations, the conveyance subsystem 112-2 may be omitted, and movement of the container 200 may be performed manually by staff.

A simulation circuit 170 may communicate with the ordering system 124 via the router 120. In this way, the simulation circuit 170 can obtain historical order information from the ordering system 124 to prepare models of order arrival for use in simulations. In other implementations, the simulation circuit 170 may be separated from the network served by the router 120 and may instead be accessed via the distributed communications system 136. The simulation circuit 170 may obtain information from the ordering system 124 using, for example, a virtual private network (VPN) connection. In various implementations, the simulation circuit 170 may connect to the router 132.

An operator device 174 is a computing device used by an operator (such as an engineer, developer, manager, or consultant) to access the simulation circuit 170. There is no technological requirement that the operator device 174 be located within the same network as the simulation circuit 170, because a variety of tunneling and VPN options exist for accessing the simulation circuit 170 via the operator device 174. In various implementations, a web server (not shown) may provide an interface between the simulation circuit 170 and the operator device 174.

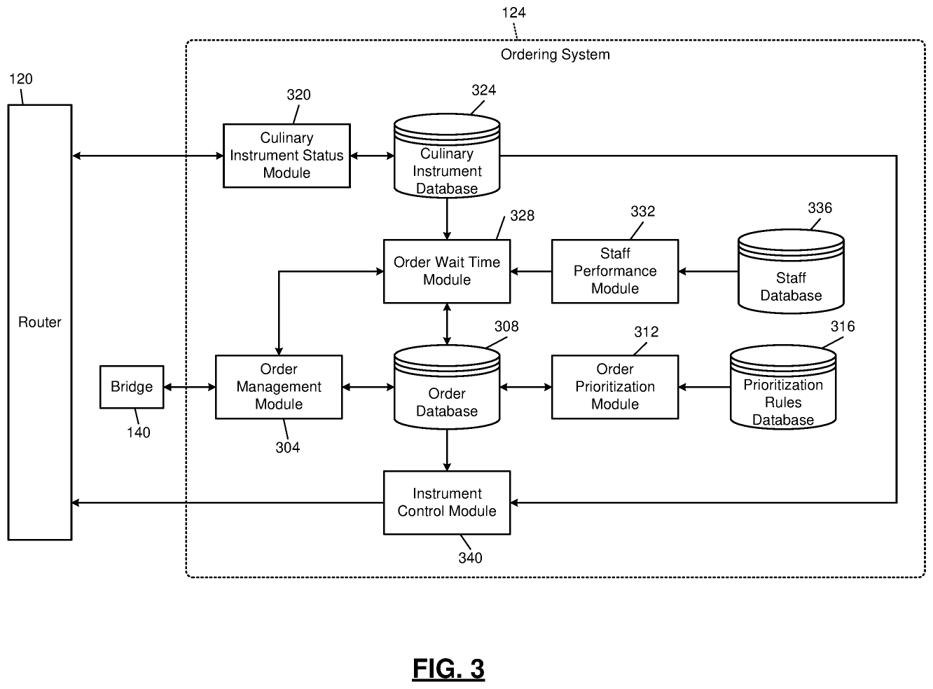

In FIG. 3, an example implementation of the ordering system 124 is shown. While various components are shown within the ordering system 124, these components are displayed only functionally and could physically or logically be located within another system, which may be located within the same or a different network. An order management module 304 receives orders placed by or on behalf of customers. For example, orders may be received via the bridge 140 from the mobile device 158-1 of customer 104-2, the mobile device 158-2 of customer 104-3, or the ordering terminal 154.

These orders are stored in an order database 308 along with information about the customer and the order. For example, metadata for the order may include the time that the order was placed, the location of the customer, whether a delivery service will be used, etc. An order prioritization module 312 accesses a prioritization rules database 316, retrieves a specified set of rules, and prioritizes orders within the order database 308 according to the set of prioritization rules.

In various implementations, there may be different sets of prioritization rules based on how many culinary instruments are in operation. Further, there may be different sets of prioritization rules depending on the time of day. For example, a certain set of prioritization rules may be used during lunch and dinner peaks, while a different set of prioritization rules may be used during less busy periods. In various implementations, different sets of prioritization rules may be used on weekdays versus weekends.

In various implementations, the order prioritization module 312 may select the appropriate prioritization rules based on a present measurement of order frequency. In other cases, the order prioritization module 312 may follow a schedule in selecting prioritization rules. The schedule may be manually defined by an operator or may be developed over time, such as based on historical data regarding the speed of order arrival throughout the day.

The orders may then be arranged in a linear sequence, with the sequence number stored in the order database 308—for example, as a field corresponding to each order. In various implementations, when multiple culinary instruments are in use, there may be a separate sequence for each culinary instrument, corresponding to a queue of orders for fulfillment by the corresponding culinary instrument.

A culinary instrument status module 320 monitors the status of the one or more culinary instruments. For example, the culinary instrument status module 320 may obtain data regarding how many culinary instruments are currently online and whether there are any interruptions or pauses in any of the subsystems. Further, the culinary instrument status module 320 may obtain warnings (such as low-stock indications for ingredients), which can then be used in estimating the likelihood of an interruption in food creation by the culinary instrument. Data about each culinary instrument is stored in a culinary instrument database 324.

An order wait time module 328 estimates wait times for each order in the order database 308. For example, the order wait time module 328 may estimate a wait time as soon as an order is placed (that is, when the order arrives in the order database 308) and may reevaluate the wait time in response to changes in status. For example, these changes in status may be obtained from the culinary instrument database 324. The order wait time module 328 may store wait times into the order database 308.

The order wait time module 328 may also send notifications to the order management module 304 for communication to customers. For example, these notifications may be sent in response to changes in the wait time that exceed a threshold. In various implementations, different thresholds may be used for increases or decreases in wait time. For example, a threshold for an increase may be specified as 20% of the previous or initial wait time, while a threshold for a decrease may be specified as an absolute length of time, such as 60 seconds, from the previously estimated wait time.

In various implementations, the order management module 304 simply obtains wait times for the order database 308 and determines whether to send notifications based on the amount of change. For example, the order database 308 may store a series of wait times determined for each order, each with an associated timestamp. Then, when a rate of change (for example, expressed as a number of minutes of wait time change divided by a number of seconds between estimated wait times) exceeds a threshold, a notification is sent.

In various implementations, some notifications may not result in a notification for a customer on their device (such as a banner notification or a badge). Instead, the notification may push data to the device so that when the user accesses the app or web page with order status, the user interface can be immediately transformed to reflect the new wait time.

The order wait time module 328 may further base wait time estimation on staff performance. A staff performance module 332 accesses records from a staff database 336 based on which staff members are currently working and, in the event of a shift change, which workers are about to begin. The staff performance module 332 may then perform weighted averaging of the currently working staff and provides those aggregated performance values to the order wait time module 328. In other implementations, the order wait time module 328 obtains specific performance data for each staff member and estimates wait time accordingly. For example, the staff performance module 332 may assess which functions each staff member is currently assigned to so that their performance on those particular tasks can be assessed and used in estimation by the order wait time module 328.

An instrument control module 340 controls execution of each order by the one or more culinary instruments. The instrument control module 340 may monitor the status of the culinary instruments, such as by accessing the culinary instrument database 324. The instrument control module 340 determines when each culinary instrument is ready to receive another order and dispatches an order from the order database to the culinary instrument.

The instrument control module 340 may therefore be responsible for selecting which culinary instrument receives which order. In various implementations, a pre-selection of the culinary instrument may have been performed when the order was added to the order database 308 or after the orders were prioritized by the order prioritization module 312. In such implementations, the instrument control module 340 may honor that pre-selection, except in cases where the selected culinary instrument is not currently available. In various implementations, the instrument control module 340 may only deviate from the pre-selection when the unavailability of the selected culinary instrument is expected to last longer than a certain threshold, such as 60 seconds. In this way, the orders going to that culinary instrument may be delayed by up to 60 seconds, but the orders directed to the other culinary instruments will be unaffected.

The instrument control module 340 controls the culinary instruments to produce each order in sequence. In various implementations, the instrument control module 340 transmits an order to a corresponding culinary instrument as soon as the culinary instrument is physically ready to begin preparing that order. In other implementations, the instrument control module 340 sends the order to the culinary instrument prior to physical readiness, and the culinary buffers the order until physical preparation can begin. In various implementations, if the culinary instrument becomes unavailable while an order is buffered and waiting to begin preparation, the instrument control module 340 may reassign the order to a different culinary instrument and instruct the culinary instrument to delete or invalidate the order from the buffer.

Further, the instrument control module 340 may be responsible for determining whether a culinary instrument interruption will be lengthy enough that even partially prepared orders should be re-assigned, the instrument control module 340 will perform that re-assignment. Especially when partially prepared orders need to be re-assigned, an impact on the order wait time is expected, and the instrument control module 340 may directly notify the order wait time module 328 to trigger a recalculation.

Though labeled as databases for illustration, the order database 308, the prioritization rules database 316, the culinary instrument database 324, and the staff database 336 may be implemented as one or more varieties of data storage that are not limited to a database, such as a structured query language (SQL) relational database. For example, additional options include a column store, a linked list, a data warehouse, and, in some cases, even an array. Further, while depicted as separate databases for functional purposes, some or all of the data may be co-located within one or more data stores. As just one example, a single database may be used for all of the illustrated “databases,” with each illustrated database corresponding to certain tables in the schema of the single database.

### Flowcharts

In FIGS. 4A and 4B, an object-oriented approach to an order is shown in flowchart form. In essence, each new order is associated with a new instance of control according to FIGS. 4A and 4B. Therefore, in response to a new order being received, control begins at 400. At 400, control determines an order position within the queue and assigns a value P indicating the position. For example only, a value P of one indicates that the order is next to be prepared, while a value P of two indicates that the order is one away from being prepared. A value P of zero may indicate that the order is currently being prepared.

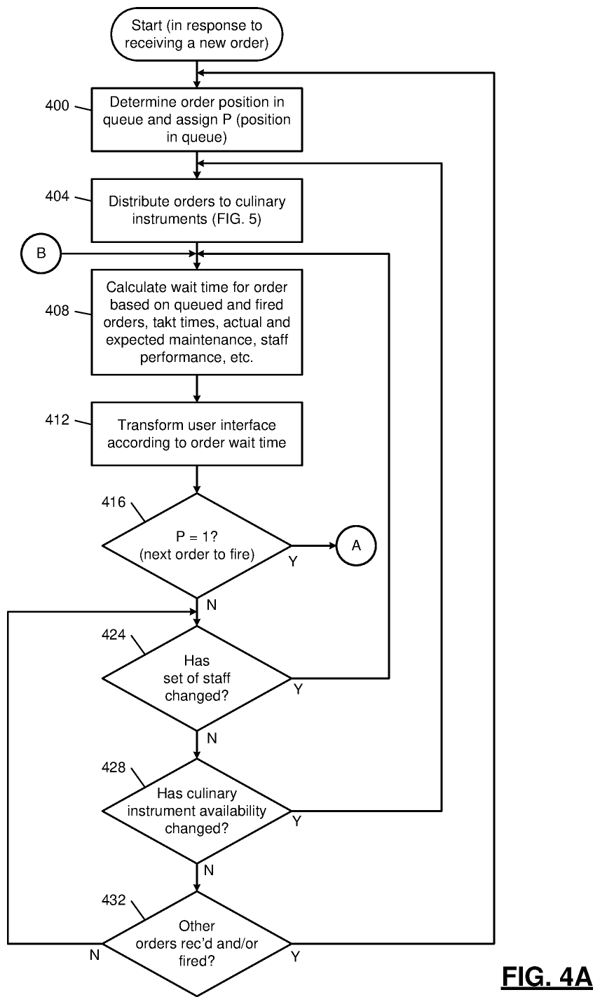

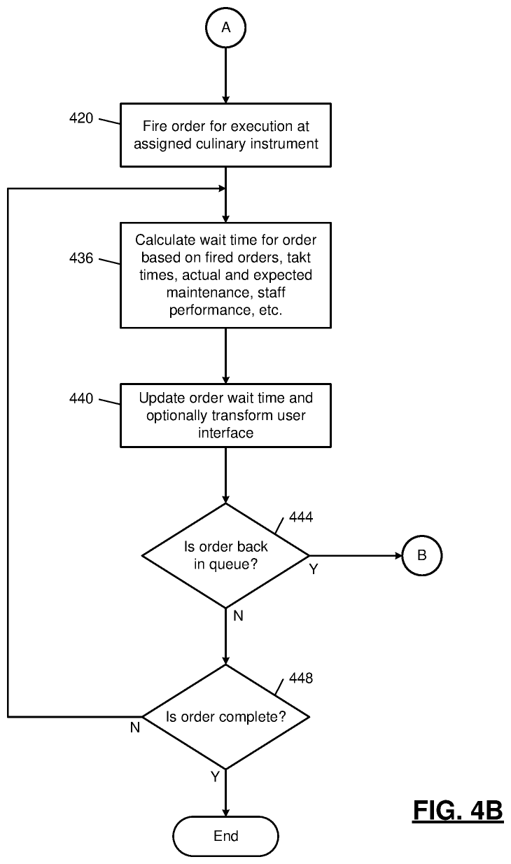

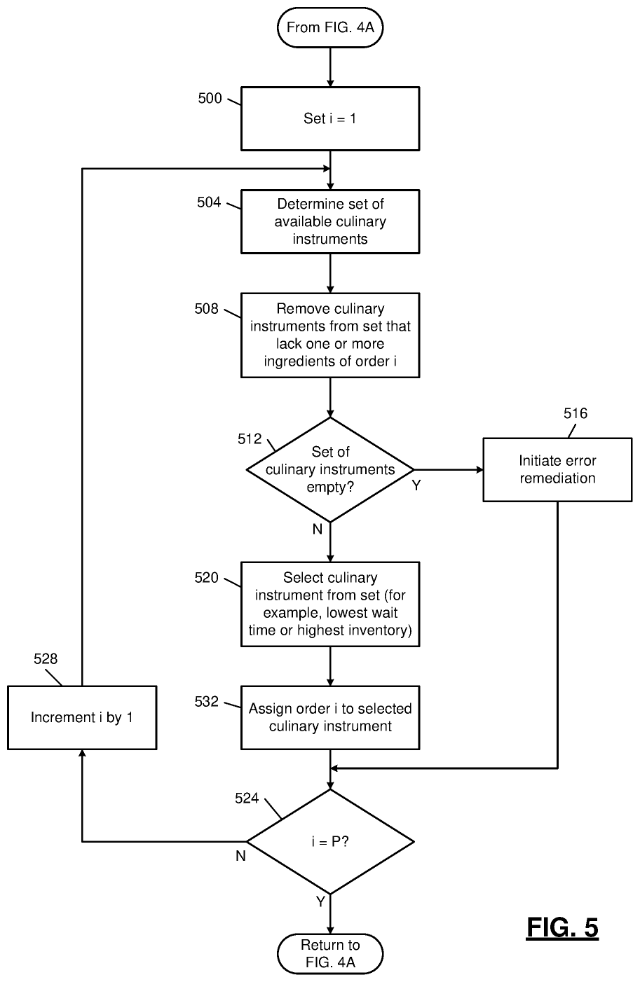

At 404, control distributes orders among the culinary instruments. For example, this may be performed as shown in FIG. 5. In a simple implementation, the newly added order may simply be assigned to whichever culinary instrument has fewer corresponding orders in the queue, assuming that the culinary instrument has the required ingredients for the order.

At 408, control calculates a wait time for the order based on orders further ahead in the queue, orders currently being prepared (initiating preparation may be referred to as firing and therefore in-process orders may be referred to as fired orders), takt times, actual measurements of the culinary instruments, expected maintenance of the culinary instruments, staff performance, etc. The term takt time refers to the amount of time required for each subsystem to prepare one aspect of the food. In a pipelined food creation system, the takt time of each subsystem will generally be the same so that each order can advance to the next subsystem at the same time. The takt time may limit how much work a subsystem can perform—for example, the number and/or volume of sauces that can be dispensed, the amount of heat that can be applied to cheese, etc.

For example, the following equation may be used in estimating a wait time.

$${t}_{r} = ( ( P * \frac{{t}_{t}}{R} ) - {t}_{l} ) + {t}_{p} + {I}_{p f}$$

tᵣ: time remaining until a specific meal production will/would be complete
P: position in waiting queue (0 if meal is already in production)
tₜ: producer takt time (time between production starts)
R: quantity of producers in the automated system
tₗ: time since last production was started on next producer (0 if meal is already in production)
tₚ: expected time of remaining production tasks for the specific meal
I_{pf}: impact of potential failure, derived from historical incidence & impact (can take into account a vast number of factors, live or historical)

At 412, control transforms a user interface according to the wait time. For example, this may involve displaying a time (for example, with a resolution of minutes or seconds) on the same user interface used to order the food and confirm the order. In various implementations, another user interface for the entire restaurant may be transformed, such as a leaderboard or display wall. On a leaderboard, customers' orders may be referred to using shorthand for privacy reasons, such as a person's first name and order number.

At 416, control determines whether the current order is now at position one in the queue. If so, the order is the next to be prepared (fired) by the culinary instrument and control transfers to 420 of FIG. 4B; otherwise, control transfers to 424. At 424, control determines whether the set of staff currently working has changed. If so, this may affect order wait times and therefore control returns to 408; otherwise, control continues at 428. At 428, control determines whether culinary instrument availability has changed. If so, control returns to 408; otherwise, control continues at 432. At 432, control determines whether other orders have been received and/or fired. If so, control may need to reassess the order's position in the queue and therefore control returns to 400; otherwise, control returns to 424.

In FIG. 4B, control commands the assigned culinary instrument to begin preparing the order. Control continues at 436, where control calculates the wait time for the order based on fired orders ahead of the current order on the culinary instrument, takt times, maintenance and other and other culinary instrument data, staff performance, etc.

In various implementations, this wait time may simply be based on a summation of takt times of the subsystems remaining to prepare the order. One complication is that, because of preceding orders in the pipeline, the order may need to wait at a subsystem even if that subsystem will not be needed for order preparation. Therefore, the estimation of wait time may be based on the summation of the takt times of all further subsystems encountered by the order. In various implementations, the wait time estimation may be made more precise by determining which subsystems will need to process preceding orders in the pipeline to determine whether any subsystems can be skipped—the takt times for those subsystems can be removed from the summation.

At 440, control updates the order wait time and optionally transforms a user interface according to the updated order wait time. In various implementations, different user interfaces are transformed at different intervals. For example, a leaderboard display within the restaurant may be updated once every 1 second, every 2 seconds, or every 10 seconds, while wait times on customer devices may be updated once per minute. In various implementations, mobile devices may poll the system for wait times and therefore are updated at whatever polling frequency is set by the app or web site running on the mobile devices.

Control continues at 444, where control determines whether the order has been placed back into a queue. If so, that indicates that the culinary instrument is unavailable and the order is expected not to be completed. Control then returns to 408 of FIG. 4A. Otherwise, if the order is still in process, control continues to 448. At 448, control determines whether the order has been completed. If so, control ends; otherwise, control returns to 436.

In FIG. 5, an example implementation of control for assigning orders to culinary instruments is presented. Control begins at 500, where a counter variable i is set equal to one. At 504, control determines the set of available culinary instruments. At 508, control determines which ingredients are required for the ith order and removes culinary instruments from the set that lack one or more of the required ingredients. At 512, control determines whether the set of culinary instruments is now empty. If so, control transfers to 516; otherwise, control transfers to 520.

At 516, control initiates error remediation. For example, control may send a notification to a manager or concierge of the restaurant to indicate that an order cannot be fulfilled. In other cases, the error remediation may involve an automated interaction with the customer to see whether the customer is willing to adapt their order to fit the available culinary instrument(s). For example, this automated interaction may identify ingredients that are no longer available and offer substitutes that are available. In some circumstances, entirely different menu items may be offered, and discounts and prioritization of order preparation may be offered to the customer in return for accepting a modified order. Control then continues at 524.

At 544, control determines whether i is equal to P. If so, the order being handled by FIGS. 4A and 4B has been assigned to a culinary instrument and therefore control returns to FIG. 4A; otherwise, control continues at 528. At 528, control increments i by one and returns to 504.

Meanwhile, at 520, control selects a culinary instrument from the set of available instruments. If the set only includes a single culinary instrument, that culinary instrument is selected. If there are multiple culinary instrument, control may select the culinary instrument based on, for example, the lowest wait time or the highest inventory of one or more ingredients. Control continues at 532, where control assigns order i to the selected culinary instrument. Control then continues at 524.

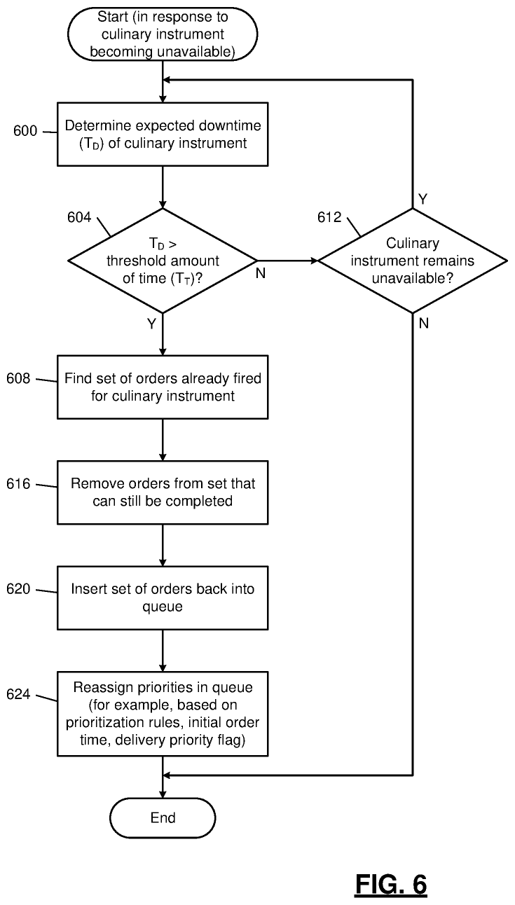

In FIG. 6, example operation of the system in response to a culinary instrument becoming unavailable begins at 600. At 600, control determines the expected downtime of the culinary instrument. For example, this may be based on a table of times corresponding to different causes of downtime. In various implementations, information about performance of staff (which may be specific to currently working staff) may be used to adjust some or all of these values. Further, an assessment of current staff utilization may affect these values. For example, if there are multiple issues across the restaurant, such as multiple ingredients out of stock on one or more machines, the staff members will already be occupied, and the expected downtime may need to be increased.

At 604, control determines whether the expected downtime is greater than a threshold amount of downtime. If so, control transfers to 608; otherwise, control transfers to 612. At 612, the expected downtime is less than the threshold and therefore control does not reassign orders from that culinary instrument. Later, control continues to check that the expected downtime does not creep past the threshold. Therefore, if the culinary instrument remains unavailable, control returns to 600. If, however, the culinary instrument unavailability has ended at 612, control ends.

Meanwhile, at 608, the expected downtime is such that the orders will be reassigned rather than waiting for the culinary instrument to return to availability. Control begins by identifying the set of orders already fired on the culinary instrument—that is, the orders where preparation has begun. For example, these orders may have a position of 0, but are not yet marked as complete.

At 616, control removes orders from the set that can still be completed by the culinary instrument. For example, an interruption in an early subsystem may be isolated while later subsystems can still function as normal. At 620, control inserts the remaining items from the set of orders back into the queue.

At 624, control may reassign priorities in the queue. For example, control may assess the initial order time and a delivery priority flag according to a set of prioritization rules. For example, certain prioritization rules may prioritize preparation of orders in time to meet a delivery vehicle. These decisions may be made based on considerations such as contractual guarantees and/or monetary incentives with respect to timeliness of providing orders to delivery vehicles. Meanwhile, the prioritization rules may set a cap of how much the delivery priority may impact the sequence of orders to avoid the spectacle of delivery vehicles being serviced promptly while in-person customers wait indefinitely for their food.

Delivery orders may also be deprioritized to match the timing of the order preparation to the arrival of the delivery vehicle. This may be important because a delivery vehicle will already introduce some delay, and maximizing freshness therefore requires the order to be ready as close to the moment the delivery vehicle arrives as possible. After priorities are reassigned, control ends.

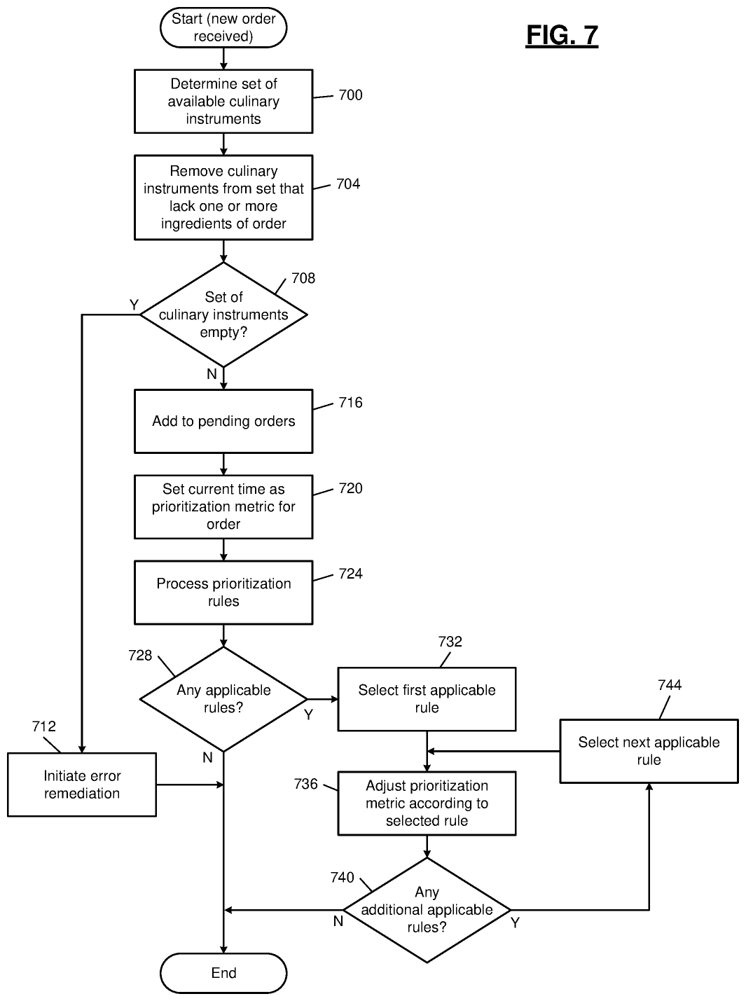

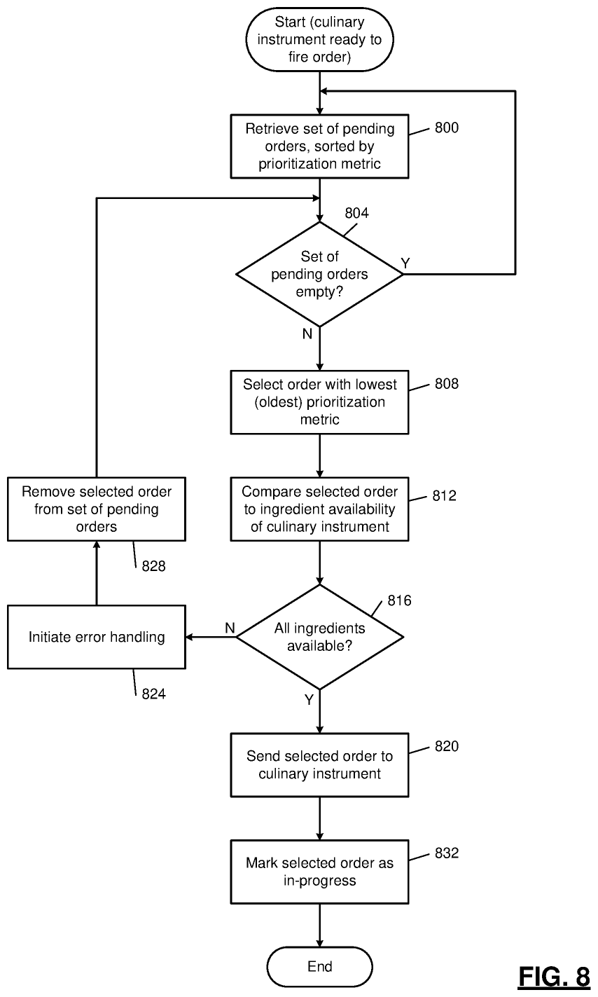

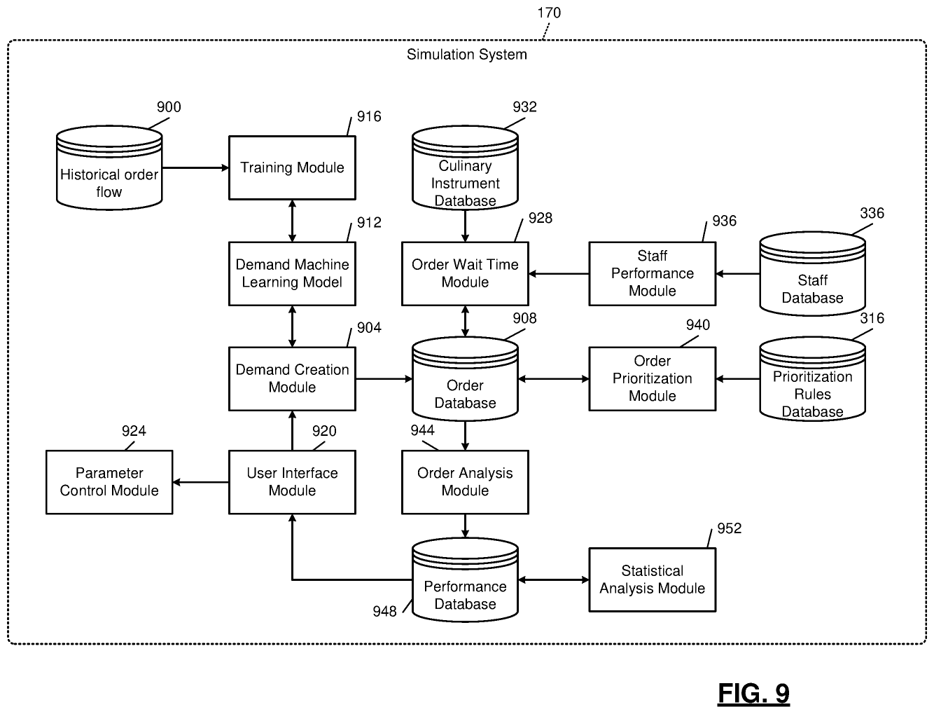

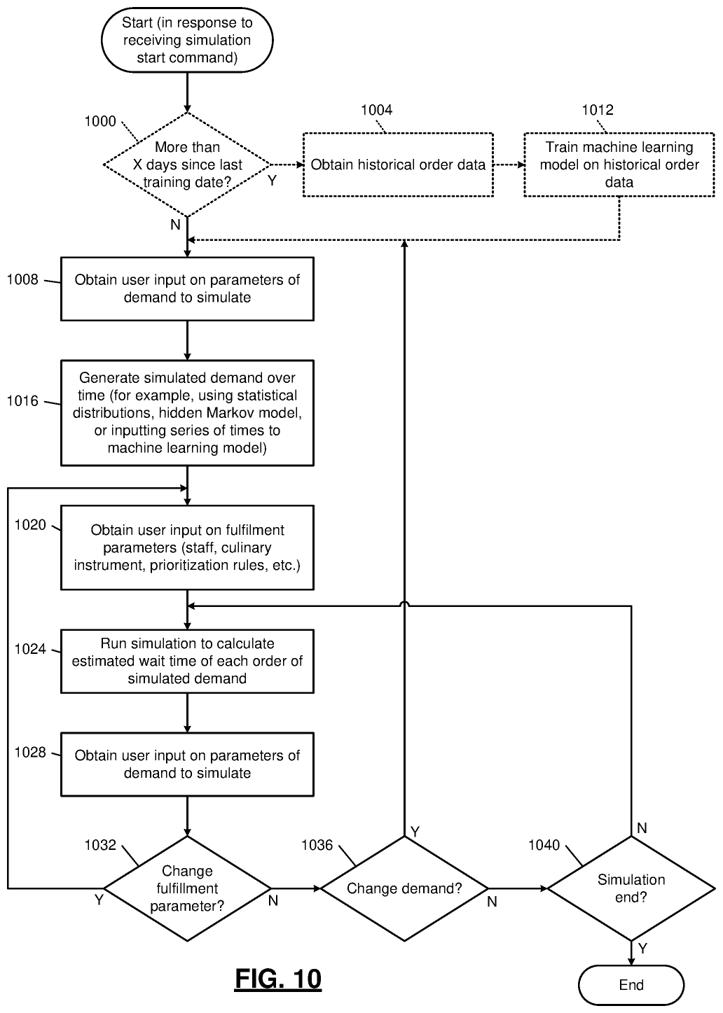

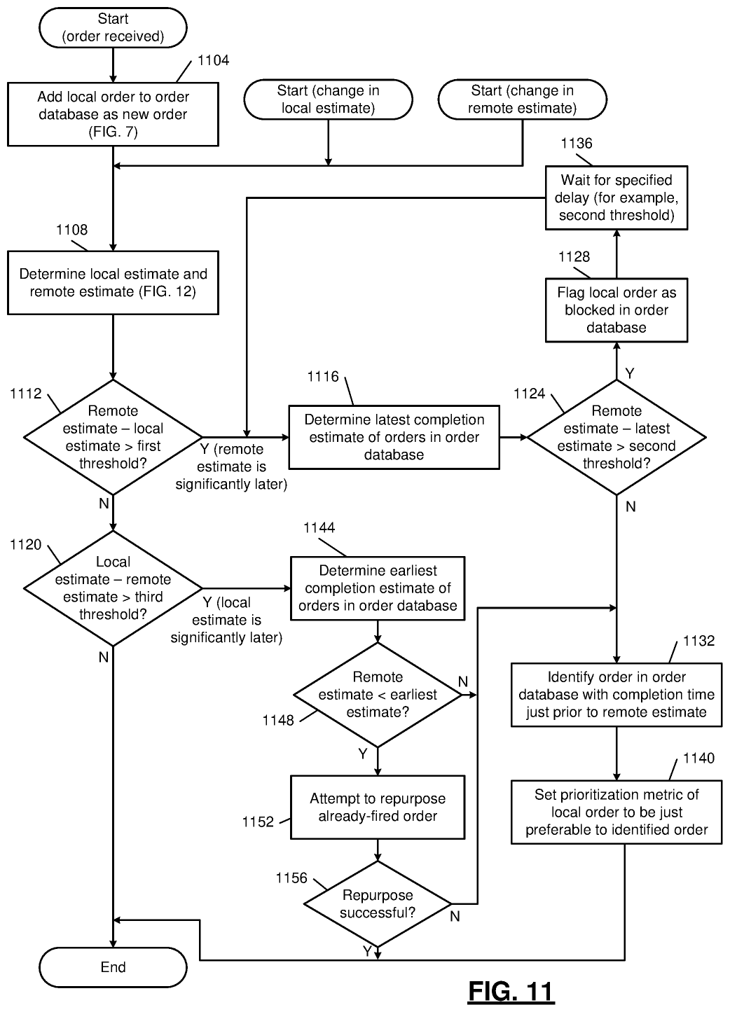

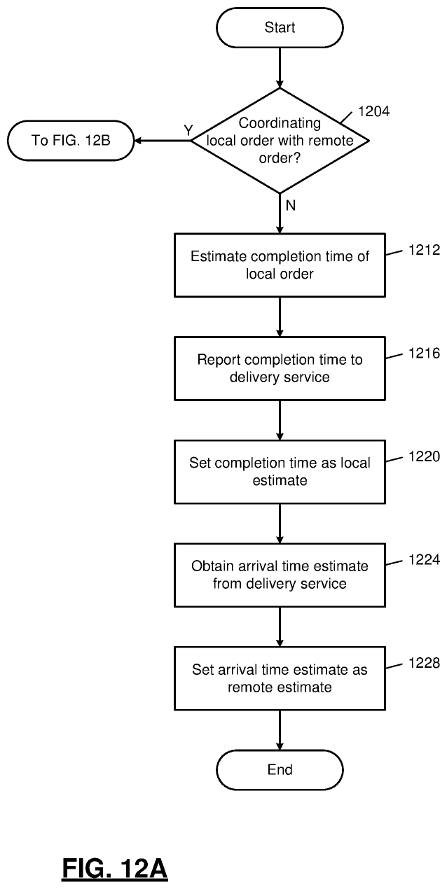

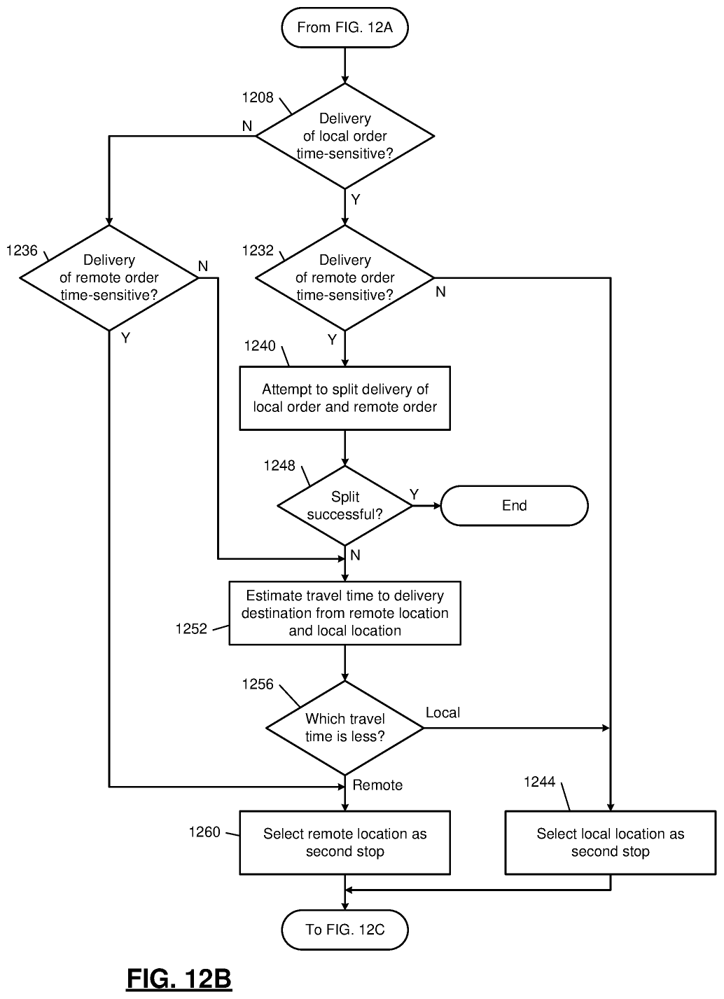

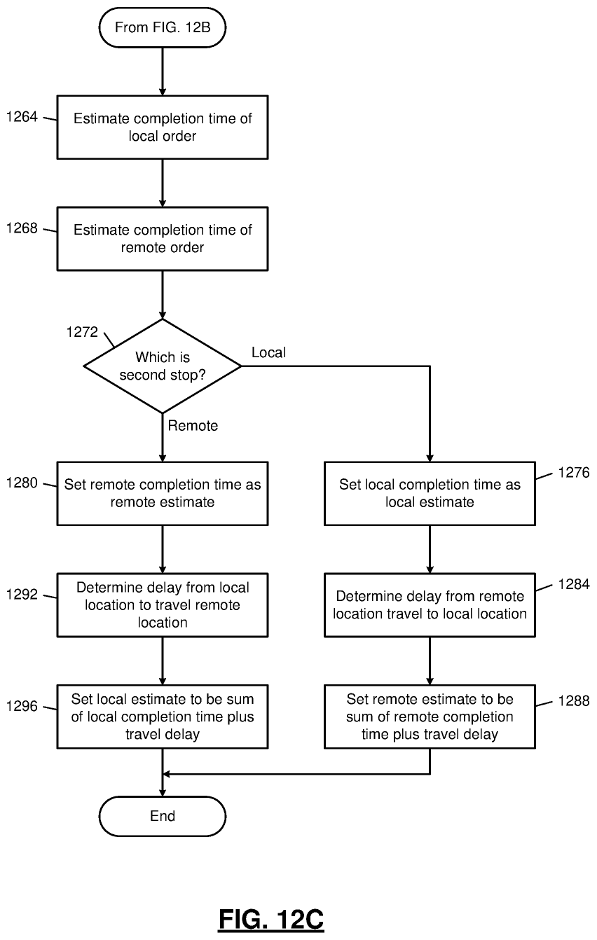

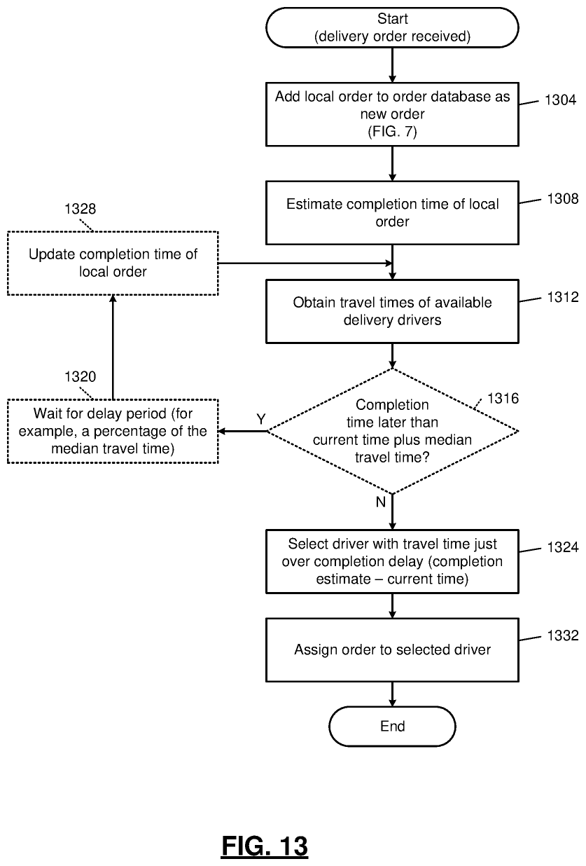

FIG. 7 represents another example of how to process a new order.

Control begins at 700 in response to a new order being received. Control determines a set of currently available culinary restaurants. In various implementations, these culinary instruments do not need to be in the same location. For example, the available culinary instruments may be determined based on a geographic radius of the delivery location. However, for an in-person customer, the set of available culinary instruments may be restricted to those in the same location as the customer.

At 704, control determines what ingredients are necessary for the order. Control removes any culinary instruments from the set that lack one or more ingredients required for the order. At 708, control determines whether the set of culinary instruments is now empty. If so, control transfers to 712; otherwise, control transfers to 716. At 712, control initiates error remediation. For example, this may be the same as or similar to the error remediation discussed above with respect to 516. Control then ends.

At 716, control adds the order to the set of pending orders, and in various implementations, does not assign the order to a particular culinary restaurant. At 720, control sets the current time as the prioritization metric for the order. The resolution of the timestamp may be, as examples only, a second, a tenth of a second, or a hundredth of a second. Using current time as the initial prioritization metric means that orders placed earlier have a lower prioritization metric, and therefore lower metrics should result in the order beginning preparation sooner.

At 724, control processes prioritization rules. For example, this may involve selecting a relevant set of prioritization rules, such as based on time of day, length of queue, and/or based on the rate at which orders are arriving. Control may then determine whether any prioritization rules from the selected set are relevant to the current order. At 728, if one or more rules are applicable, control transfers to 732; otherwise, control ends.

At 732, control selects the first applicable prioritization rule. At 736, control adjusts the privatization metric according to the selected rule. For example, the selected rule may apply a positive or negative adjustment to the prioritization metric. In the example described above, where the prioritization metric is initially set equal to a timestamp, subtracting a value from the prioritization metric will serve to speed the order along, while adding a value to the prioritization metric will serve to slow the order.

The privatization rules may scale the adjustment according to current conditions. For example, when a number of in-person customers waiting for an order is high, the adjustment for a delivery service order may be reduced. In other implementations, each rule is associated with a static adjustment applied to the prioritization metric. For example, an in-person order may correspond to a first prioritization rule having a first adjustment. A delivery order may correspond to a second prioritization rule having a second adjustment. A re-order based on a real or perceived problem with a prior order may correspond to a third prioritization rule and have a third prioritization adjustment. Control continues at 740, where if there are any additional applicable pressurization rules, control transfers to 744; otherwise, control ends. At 744, control selects the next applicable prioritization rule and continues at 736.

FIG. 8 is a flowchart of example control performed in response to a culinary instrument being ready to begin preparation of an order. Control begins at 800 by retrieving a set of pending orders, sorted by prioritization metric. Control determines at 804 whether the set of pending orders is empty. If so, control returns to 800; otherwise, control transfers to 808. At 808, control selects, from the set, the order that has the lowest prioritization metric. In other words, control selects the earliest order, as modified by any prioritization rule adjustments.

At 812, control compares the ingredients required for the selected order to the ingredients available at the ready culinary instrument. At 816, if all of the necessary ingredients are available, control transfers to 820; otherwise, control transfers to 824. At 824, control optionally initiates error handling. For example, this may involve checking whether any other culinary instruments in operation have all the ingredients. If so, those culinary instruments will be able to process the oldest order when they are next available to begin processing. However, if no currently available culinary instruments have all the ingredients, error remediation—such as is discussed above at 516—may be performed. Control continues at 828, where control removes the selected order from the set of pending orders. This allows the culinary instrument to attempt to process the next order. Control therefore returns to 804 to determine whether there are any remaining orders in the set.

Meanwhile, at 820, the culinary instrument has the necessary ingredients to prepare the order and therefore the culinary instrument is instructed to prepare the selected order. Control continues at 832, where the selected order is marked as in-progress in the order database. Control then ends.

### Simulation

In FIG. 9, an example implementation of the simulation circuit 170 includes a historical order flow data store 900. The data store 900 may store model information that describes order flows from prior periods of operation of a culinary instrument or restaurant. For example, the data store 900 may include data encoding the number of orders received per minute for each minute that the restaurant was open.

This data may be based on statistical analysis, such as averaging. For example, for each minute in a Monday, the number of orders per minute may be characterized by a mean and a standard deviation, which represent a Gaussian distribution. In other implementations, this data may be aggregated separately across weekdays and weekends such that there is a modeled order flow for a weekday operation and a modeled order flow for a weekend operation. In various implementations, some historical order flows may be recorded with more precise timing detail. For example, all orders received in a certain day may be tracked, along with the exact timestamp when each order was received.

In addition to number of orders, the data store 900 may encode data regarding the size of each other. For example, a single order may contain multiple menu items. In queueing orders and controlling the culinary instruments, these orders may be separated into single-item orders to allow for simplicity in queuing and firing. Depending on the prioritization applied, all of the segregated orders from a combined order may be prioritized equally because they share a timestamp and will likely have the same prioritization rules applied to each.

For simulation purposes, a demand creation module 904 may generate a series of simulated orders for insertion into an order database 908. In various implementations, the order database 908 may be implemented similarly to or identical to the order database 308 of FIG. 3. In fact, the databases of the simulation circuit 170 may be hosted in the same system as the databases of the ordering system 124. Still further, the simulated orders in the order database 908 may be stored in another table of the order database 308. For example, this other table or set of tables may have the same schema as the table(s) for live orders in the ordering system 124.

The demand creation module 904 may generate orders based on a machine learning model 912. The machine learning model 912 generates demand values, which may be, for example, a number of orders per minute and may even specify the sizes of the orders. Then, the demand creation module 904 can generate orders according to these parameters for sending to the order database 908. In various implementations, the demand creation module 904 may randomize each order to be a random menu item with a random set of ingredients. In other implementations, there may be a predefined set of menu item configurations and each order may be selected from those.

The demand creation module 904 may output orders to the order database 908 at an even pace or at random times. For example, if the currently simulated demand model might expect to see five orders in the present minute, the demand creation module 904 may output each order to the order database spaced apart by 12 seconds. In other implementations, the demand creation module 904 may randomize the amount of time between orders within that minute, which will sometimes result in two orders having similar or even identical timestamps.

The demand machine learning model 912 may be trained from the data store 900 by a training module 916. The feature vector created by the training module 916 may include a day of the week, a time, average number of orders for that time, an average size of the order, etc. The demand creation module 904 may therefore feed the demand machine learning model 912 a time of day and receive back an average number of orders per minute and a size of the orders.

The simulation circuit 170 may be under the control of an operator (also referred to as a user) via a user interface module 920. The user interface module 920 may control demand creation, such as by selecting which day of the week to simulate. Further, the operator can specify demand curves that are different than those that have occurred historically.

Via the user interface module 920, the operator may also control parameters in the parameter control module 924, such as the probability of a culinary instrument interruption, the duration of a culinary instrument interruption, etc. In various implementations, the user interface module 920 may allow the operator to define these parameters statistically, such as with a mean, a standard deviation, and optionally lower and/or upper limits. The user interface module 920 may also allow the operator to adjust the aggregated order size (number of items per order), such as with mean, standard deviation, minimum, and maximum.

In various implementations, the user interface module 920 may allow the operator to specify a distribution within a period of time during which orders are received. For example, this models order arrival as a Gaussian distribution over time. As a more specific example, with a lunch rush of 120 minutes, the peak of the orders may arrive at approximately noon with a Gaussian roll-off towards 1 PM and towards 11 AM. In such implementations, the user interface module 920 may allow the user to specify the Gaussian distribution of orders versus time using mean, standard deviation, minimum, and maximum.

The parameter control module 924 may also allow the operator to specify overall parameters, such as number of culinary instruments, takt time, production time, total number of orders to create, etc. Further, the parameter control module 924 may allow the operator to specify one or more parameters to vary over the course of a number of simulations. For example, the operator may request 500 simulations to be done—50 each for each of 10 different values of culinary instrument interruption probability. For each value of probability, 50 simulations are run and their outputs combined together (such as using an average). Various metrics may be calculated for each of the 10 probability values. For example, an average wait time, a standard deviation, and a maximum wait time may be determined for each of the 10 values of the parameter. In various implementations, one set of metrics may be determined for orders received during a peak period and another set of metrics for orders received outside of the peak periods.

In a simulation, demand creation module 904 simulates demand according to the parameters configured in the parameter control module 924. An order wait time module 928 calculates wait times for each order based on a culinary instrument database 932, which may be modified according to parameters set by the parameter control module 924.

The order wait time module 928 may also incorporate information from a staff performance module 936, which obtains data from the staff database 336 (or a copy, mirror, etc. of the staff database 336). The staff performance module 936 may modify staff performance parameters under the control of the parameter control module 924.

An order prioritization module 940 prioritizes orders in the order database 908 based on sets of rules from the prioritization rules database 316 (or a copy, mirror, etc. of the prioritization rules database 316). In various implementations, prioritization rules may be modified by the parameter control module 924 to test out different sets of rules under different scenarios.

An order analysis module 944 monitors wait times in the order database 908 and stores information about the wait times into a performance database 948. A statistical analysis module 952 determines metrics related to the orders, such as mean wait time, standard deviation of wait time, and maximum wait time. The statistical analysis module 952 may also bin wait times to produce histogram data indicating the proportion of orders experiencing different ranges of wait times. The binning may be automatically determined by the statistical analysis module 952 or the bins may be defined by the user in the parameter control module 924. The statistical analysis module 952 stores the determined metrics in the performance database 948. The operator can access the performance database 948 via the user interface module 920.

As one specific example, for illustration purposes only, the following pseudocode may be used to calculate wait times and culinary instrument availability (also known as uptime).

instruments = [
{‘available_at’: 0, ‘burgers_until_next_pause’: round(PAUSE_INTERVALS.pop( )), ‘pauses’: [ ]}
for r in range(QTY_INSTRUMENTS)
]
wait_times = [ ]
for simulation_order_times in order_times_by_simulation:
for instrument in instruments:
instrument[‘available_at’] = 0 # instruments always start available (even if pause imminent)
instrument[‘pauses’].append([ ]) # group instrument pauses by simulation
for order_at in simulation_order_times:
available_at_by_instrument = [r[‘available_at’] for r in instruments]
next_instrument_available_at = min(available_at_by_instrument)
next_instrument = instruments[available_at_by_instrument.index(next_instrument_available_at)]
fire_at = max(next_instrument_available_at, order_at)
next_instrument[‘available_at’] = fire_at + TAKT_TIME
next_instrument[‘burgers_until_next_pause’] −= 1
if next_instrument[‘burgers_until_next_pause’] == 0:
next_pause_duration = min(PAUSE_DURATIONS.pop( ), SERVICE_DURATION − fire_at)
next_instrument[‘burgers_until_next_pause’] = round(PAUSE_INTERVALS.pop( ))
next_instrument[‘available_at’] = fire_at + next_pause_duration
next_instrument[‘pauses’][−1].append([fire_at, fire_at + next_pause_duration])
wait_times.append((fire_at − order_at) + (PRODUCTION_TIME / 60.0))

This code is one implementation of a simulation approach that iterates over each order chronologically, tracking the culinary instruments' next available times and next interruptions to determine the next order's wait time. Information about when the next culinary instrument will be available is based on previously fired orders. This particular implementation simplifies the impact of a culinary instrument interruption to an inability to begin preparation of new orders, and does not take into account the fact that orders already in the preparation process may be affected as well.

In FIG. 10, a flowchart depicts simplified operation for executing a simulation. Upon receiving a simulation start command, control begins at 1000. If it has been more than a specified period of time (such as a specified number of days) since the last training date of a machine learning model, control transfers to 1004; otherwise, control continues at 1008. At 1004, control obtains historical order flow data. At 1012, control trains a machine learning model on the historical order data. Control then continues at 1008. In various implementations, order flow may be simulated stochastically rather than with a machine learning model and, in such cases, 1000, 1004, and 1012 may be omitted.

At 1008, control obtains user input on parameters of demand to simulate. For example, this user input may have been provided to a parameter control module via the user interface module. At 1016, control generates simulated demand over time. For example, this generation may use a statistical distribution, a hidden Markov model, or the above machine learning model, where the input values provided to the machine learning model may be a series of timestamps.

At 1020, control obtains user input on fulfillment parameters, such as staff performance, culinary instrument availability, prioritization rules, etc. This user input may have been provided to a parameter control module through a user interface module. At 1024, control runs a simulation over a period of time (such as a day, a lunch service, or a dinner service) to calculate the estimated wait time of each order from the simulated demand.

At 1028, control obtains user input on which parameters to vary in simulation. For example, the user may have specified that a range of fulfillment parameters should be tested. At 1032, control determines whether a variation to a fulfillment parameter is specified. If so, control returns to 1020; otherwise, control continues at 1036. At 1036, control determines whether the varied parameters include a change in demand. If so, control returns to 1008; otherwise, control continues at 1040.

At 1040, control determines whether a simulation end has been reached. If so, control ends; otherwise, control returns to 1024 to continue running simulations to achieve multiple rounds of input, which may be averaged together. The number of simulations may have been specified by the operator and once the requested number of simulations is performed, the simulation ends. In various implementations, the operator may actuate a user interface element to end the simulation. In various implementations, the simulation may be ended once the average of various metrics (such as average order wait time) has converged. As an example only, convergence may be determined when the average of a metric changes by less than a threshold (such as 2%) over the last N simulation runs (where N may be 1, 2, or a higher number).

### Coordination

In various implementations, a first operator of a first fulfillment operation (such as a restaurant) may want to coordinate preparation of an order with a remote actor. The remote actor may be, for example, another location of the first operator, a different operator, a delivery service, a micro-fulfilment center (MFC), or a customer. In other words, the remote actor may be a third party operation or may be a first-party operation (operated by the first operator). In various implementations, the first fulfillment operation may be a ghost, or dark, kitchen, a restaurant with no front-of-house: that is, a delivery-only restaurant (with, in some cases, an in-person pickup option).

As one example, if the first operator is preparing a single customer's food order in two different locations, coordinating preparation of the food order across the two locations may be necessary to maximize the freshness of both portions of the order when they arrive at the customer. In other words, if a driver will be collecting a first part of the order from the first fulfillment operation and taking the first part to a second location, ideally the second part of the order would be completed just as the driver arrives to the second location.

When interfacing with a delivery service—which may be the first operator's delivery service or a third-party delivery service—completion of the order may be coordinated with arrival of the delivery service's representative at the first operator's location. For example, when the delivery service uses automobiles with human drivers, it may be advantageous to complete the order moments before the human driver arrives to pick up the order. In some cases, an item (such as a food item) may need to cool or warm for some period of time before being safely transported. In such cases, the completion time of the order may be adjusted according to how long the order should cool (such as in the case of a freshly baked cookie) or warm (for example, a food item that is refrigerated but may be intended for consumption at room temperature).

The arrival time may be as simple as determining an estimated arrival time based on current traffic conditions. In various implementations, the arrival time can incorporate additional factors, such as the amount of time it takes for the driver to park their vehicle and navigate to a retrieval location, such as a pickup window. As just one example, a two-minute walk from a parking lot to a pickup window may be added to estimated drive time to estimate the arrival time.

For purposes of order coordination, a customer may be similar to a delivery service. Again, the order should be completed just prior to arrival of the customer at the retrieval location.

The order may also be coordinated with an order prepared by a third party. For example, the first operator may be preparing a fresh food order, while the third party—such as a micro-fulfillment center (MFC)—is preparing a grocery order. In this disclosure, the term “grocery” is used simply as an example—the order may actually be home improvement products, consumables, sundries, dry goods, etc.

The third-party order may be coordinated with the local order so that a single delivery mechanism (such as a delivery driver in an automobile) is able to pick up both orders and bring them to one or more destinations (such as the residence of one or more customers) as quickly as possible and with the most time-sensitive food having the least transit time. For example, if delivering groceries or other sundries along with a hot meal, the hot meal may be picked up second to minimize heat loss, thereby maximizing freshness when the order arrives at the customer.

Coordination of a local order with another actor may be performed by the order management module 304 of FIG. 3. The order management module 304 may communicate with the other actor via the bridge 140. In FIG. 11, example operation of order coordination is shown. While the implementation of coordination here represents one example, many other examples are within the scope of the present disclosure. For example, any combination of push and pull communications may be used.

In a push arrangement, the system may receive updates as the status or location of the remote actor changes. For example, updates may be pushed periodically, or in response to changes that exceed a threshold. Such pushed updates may include, for example, a change in estimated completion time of another order, arrival time of a delivery driver, arrival time of a customer, etc. In a pull arrangement, the system may periodically request status updates and compare the responses to existing data. This may also be referred to as polling. The requests may not be exactly periodic, and may vary based on other workloads. In addition, the periodicity may vary over time and may vary across different remote actors. For example, some third parties may expose their status, such as via an application programming interface (API), but may restrict how frequently a single actor can call the API.

In various implementations, the first operator may interface with a third party in a controller-agent relationship, where the first operator acts in the capacity of an agent and the third party acts as the controller. The third party may query the first operator to determine an estimated completion time of the order or a status of the order (such as whether the order has been started, how much of the order has been prepared, whether the order can be put on hold, etc.). The third party may then track the timing of the delivery vehicle (for example, based on location) and simply instruct the first operator regarding when to start the order and/or at what time to have the order complete.

In FIG. 11, control begins at 1104 when an order is received. This order is referred to as the local order. At 1104, control adds the local order to the order database as a new order. For example, this may be performed as shown in FIG. 7. At 1108, control determines local and remote estimates. For more details of one example of determining these estimates, see FIGS. 12A-12C.

The local estimate is based on the completion time for the local order. This may also include the transit time for the local order to arrive at some second location, such as if a second order will be subsequently picked up on the way to the customer. The remote estimate is based on a remote actor—such as a delivery driver, customer, or other order fulfillment operation—and what time they will either be complete with another order or arrive at the local location. In any case, the terms local estimate and remote estimate are then used in the rest of this example flowchart so that this particular approach could be used regardless of what type of remote actor is being coordinated with.

At 1112, control determines whether a difference between the remote estimate and the local estimate is greater than a first threshold. If so, indicating that the remote estimate is significantly later than the local estimate, control transfers to 1116. Otherwise, control transfers to 1120. At 1116, control determines, from among all of the orders in the order database, what the latest completion estimate is. In other words, this determines when the final order of all existing orders will be completed. The latest estimate may be adjusted, such as by adding on a travel time from the local location to the remote location.

At 1124, if the difference between the remote estimate and the latest estimate is greater than a second threshold, indicating that even the final order in the order database will be completed well before the remote estimate, control transfers to 1128; otherwise, control transfers to 1132.

At 1128, control flags the local order as blocked in the order database so that it is not fired. In other words, because the local order would be completed well before the remote actor is ready, the order is delayed. In various implementations, if some preparatory actions can be taken, those may be fired. However, in implementations where creation of an order is a continuous process, the entire process is delayed to avoid preparing the order too soon and having it sit uncollected, occupying valuable storage resources and perhaps comprising the freshness of the food by losing its heat (and/or, depending on the order, coolness).

At 1136, control waits for a specified delay. For example, the delay may be equal to the second threshold. As just two examples, in various implementations the second threshold may be five minutes or ten minutes. Control then returns to 1116 after waiting for the specified delay.

At 1132, control identifies an order in the order database that has a completion time prior to the remote estimate. For example, the identified order may be the order with a completion time that is closest to the remote estimate while still being prior to the remote estimate. In various implementations, instead of using the completion time, an adjustment may be used to adjust the completion time, such as when a delivery vehicle will pick up the local order and then travel to a location of a remote order.

Control continues at 1140, where control sets the prioritization metric of the local order to be just preferable to the identified order. In other words, control causes the local order to be prepared just prior to the identified order. This may be accomplished by setting the prioritization metric to be a single increment more preferable than that of the identified order. For example, when the prioritization metric is a timestamp, the local order may be set to the prioritization metric of the identified order minus a single increment (such as a thousandth of a second or one second). Control then ends. However, note that control begins again at 1108 in response to a change in the local estimate. Further, control begins again at 1108 in response to a change in the remote estimate.

At 1120, control determines whether the local estimate is later than the remote estimate by more than a third threshold. If so, indicating that the local estimate is significantly later than the remote estimate, control transfers to 1144. Otherwise, the prioritization of the local order is appropriate (the difference between the local estimate and the remote estimate is within the first and third thresholds), so control ends without adjusting the prioritization of the local order.

At 1144, control determines an earliest completion estimate of orders in the order database. At 1148, control determines whether the remote estimate is prior to the earliest estimate. If so, indicating that even placing the local order first in the queue will not result in the local order being prepared in time, control transfers to 1152; otherwise, control transfers to 1132.

At 1152, control attempts to repurpose an already-fired order. Orders that have been fired are already in process. For example, a bun may have been dispensed and cooking of a food product, such as a hamburger, may have already commenced. In various implementations, the initial steps for one order can be repurposed to produce the local order. For example, if a food item has not been cooked beyond the desired cook level of the local order, the cooked item can be repurposed and simply cooked to the level specified by the local order.

In addition to food preparation concerns, repurposing an already-fired order may be restricted to situations where the impact to the already-fired order would not be problematic. For example, if a customer has already been waiting for more than a specified amount of time, repurposing their already-fired order may be disallowed. In various implementations, already-fired orders may only be repurposed when that will not result in a meaningful delay to the person or service receiving the already fired order.

In various implementations, repurposing an already fired order may be a premium feature provided to select partners. For example, a delivery service may highly prioritize minimizing wait times for their drivers. As a result, the delivery service may provide incentives (which may be monetary) to the operator to repurposing already fired orders to avoid any wait time for a delivery driver. Control continues at 1156, where control updates the local estimate and reports the local estimate to the remote actor.

The remote actor may delay their activity based on the local estimate—for example, a customer or delivery driver may wait to begin driving (or other mode of transportation, such as walking) until closer to the local estimate. For example, the remote actor may time their order preparation, driving, or other activity so that their arrival at the local location aligns with the local estimate. Or, in the case of a service collecting the local order and taking the order to the remote location, the remote actor may time their order preparation to complete at the time the local order arrives at the remote location. Control continues at 1160 where, if the repurposing was successful, the already-fired order will have been placed back in the queue to be prepared next and the local order will already be in process. Control then ends. Otherwise, at 1160, if the repurposing did not succeed, control returns to 1132.

In various implementations, adjustment actions (such as changes to prioritization at 1140 and/or repurposing at 1152) may be subject to a threshold analysis. Any orders whose completion time might be affected by the adjustment action may be evaluated to determine the actual change in their completion times. The adjustment action may be prevented or modified in response to a violation of threshold criteria.

For example, a relative change metric may be used for each order. The relative change metric may be the same for all orders or may be different for different orders—for example, the relative change metric may be specific to a class of order, such as having a first value for in-person orders and a second value for delivery vehicle orders. If the estimated completion time for an order will increase by more than the relative change metric in response to the adjustment action, the adjustment action may be blocked. Further, an absolute change metric may be defined for orders. If the resulting completion time of the order after the adjustment action would be later than the very first completion time estimate plus the absolute change metric, the adjustment action may be blocked.

Further, a total change count may be tracked for each order. If an adjustment action would cause the total change count of an order to exceed a threshold, the adjustment action may be blocked. This assessment prevents a single order from having a completion time that changes too many times, such as oscillating above and below the initial completion estimate. In addition, setting a threshold for total change count may prevent an unstable system response. For example, in some systems, a first order may be reprioritized in front of a second order, but then the second order may be reprioritized in front of the first order. This may occur when the system is unable to complete both the first and second orders by the time of their respective remote estimates (such as arrival of respective delivery vehicles).

Instead of blocking an adjustment action, the adjustment action may be modified. For example, if the adjustment action would have prioritized a new order as the 5th order in the queue, the adjustment action may be modified by only prioritizing the new order as the 7th order in the queue. In that example, placing the new order as the 5th order would create a threshold violation for either the 5th or 6th order in the queue, so the new order is placed in the 7th slot. In various implementations, the prioritization may be evaluated for each successive position in the queue until the adjustment action will not violate any threshold criteria.

In various implementations, if adjustment actions are blocked or modified, this suggests that some completion times will not meet the desired remote estimates. This may cause a remote actor (such as a customer or delivery driver) to have to wait. In response to this potential wait event, additional production or delivery resources may be requested. In the case of a robotic culinary instrument, additional modules and/or culinary instruments may be activated to accelerate completion times. Another example is requesting that an employee arrive at work early or shift their activity to production from, for example, maintenance.

In various implementations, the threshold for activating resources may be more than a trivial amount—calling in an employee to accelerate the production of one order (such as one or two hamburgers) may be an inadvisable decision. As another example, spooling up a second culinary instrument may be time-consuming and may require an expensive (in terms of time and/or money) decommissioning—such as a full cleaning cycle of the culinary instrument—when the rush is over. For these reasons, the additional resources may remain online even once the activation threshold is no longer exceeded. In other words, there is hysteresis to avoid toggling resources on and off.

If the combination of remote actor availability, local estimates, and remote travel time exceed some threshold of fulfillment time, the system can automatically modify orders either by preparing them in such a way that they can last longer (fresher, warmer, more sauce, etc.) or by adding premium items at discounted prices or for free so as to make up for the extended wait time.

If an order has not been completed by the time predicted by the local estimate, control may commence remedial action. For example, remedial action may include directing a refund—in terms of credit card refund, store credit, free add-ons or upgrades, etc. The remedial action may be scaled based on increments of delay beyond the local estimate, ending at the point that the order is completed. The remedial action scaling may be linear or may be logarithmic, such that, as an example, small delays lead to very small refunds but refunds quickly scale up to a maximum value as the delay increases. These remedial actions may be dictated by customer guarantees, service level agreements (SLAs), etc.

Variances between actual completion time compared to the local estimate are logged. These can be used to adjust estimation parameters as well as to adjust production inputs. For example, logging may track which human workers and/or automated systems were involved in specific instances where actual completion time exceeded the local estimate. Various changes to production, employee assignment, employee incentives, etc. can be taken in response to the logged data. In other words, unexpected breakdowns of a culinary instrument may be factored into estimates and may also be addressed directly, such as by replacing problematic systems or reducing the duty cycle of the systems.

If due to a delay or some other reason, the delivery service will arrive later than previously estimated but the product is already in production and cannot be paused or repurposed, then a storage system can be preemptively activated. For example, a heating element in a hot holding area can be preemptively warmed up in anticipation of needing to hot-hold a food item. In addition, the system can preemptively identify a need to clear space in a holding area to make room for incoming orders. The amount of room is calculated by comparing the arrival time of the remote actor (delivery resource) against the local completion time estimate, resulting in the number of orders that will need to sit in wait. This calculation may cause control to request assistance from local operators to clear space.

In FIGS. 12A-12C, example operation of determining local and remote estimates is presented. These local and remote estimates allow for the coordination of a local order with a number of varieties of remote actors. Control begins at 1204, such as when FIGS. 12A-12C are invoked by operation 1108 of FIG. 11. At 1204, control determines whether the local order is being coordinated with a remote order. If so, control transfers to 1208 of FIG. 12B. This may be the case, for example, if coordinating a local fresh food order with a remote grocery order, such as from a micro-fulfillment center. Otherwise, the local order is being coordinated with another party, such as a delivery driver or customer. In that case, the no branch is traversed to 1212.

At 1212, control estimates a completion time of the local order. At 1216, control reports a completion time to the delivery service. At 1220, control sets the completion time as the local estimate since the delivery service will be coming to the local location to retrieve the food. Although described as a delivery service, this may in fact be the customer themselves. In other words, one way of thinking about a customer pickup is as essentially being a self-fulfilled delivery service.

At 1224, control obtains an arrival time estimate from the delivery service. For example, this may rely on global positioning system (GPS) coordinates from the delivery vehicle. Again, the delivery vehicle may be the customer's own vehicle or other mode of transportation. Although GPS is described as an example, any other type of positioning or geolocation system is consistent with the present disclosure, whether it relies on satellites, wireless network locations, accelerometer data, etc.

In various implementations, the arrival time estimate may be provided by an ordering app executing on the customer's device (such as a smartphone). In various implementations, once an order is placed, the application may request that the user enable or maintain location services so that the app can provide location information to coordinate preparation of the food with arrival of the customer. This may be referred to as geofencing. In situations where an arrival time estimate is not available from the delivery service, control may simply end the attempt to coordinate and simply prepare the order as originally prioritized.

At 1228, control sets the arrival time estimate as the remote estimate. Control then ends. In other words, control then returns to the calling function, such as to 1112 of FIG. 11.

In FIG. 12B, at 1208, control determines whether delivery of the local order is time-sensitive. If so, such as when the local order is hot food ready for consumption and/or cold food that should remain cold (such as ice cream or other frozen treats), controlled transfers to 1232; otherwise, control transfers to 1236. At 1232, control determines whether delivery of the remote order is time-sensitive. If so, then delivery of both orders is time sensitive and control transfers to 1240; otherwise, control transfers to 1244.

At 1240, control attempts to split delivery of the local order and the remote order. This is because using a single delivery mechanism for both orders will make it impossible to minimize the time between completion of one order and delivery of the order to the ultimate customer. Splitting may involve assigning a second delivery option to either the local or the remote order. For example, a different driver may be assigned to one of the orders. At 1248, control determines whether the split was successful. If so, coordination is no longer applicable and control ends; otherwise, control transfers to 1252.

At 1252, control estimates a travel time to the delivery destination from the remote location and from the local location. At 1256, control determines which travel time is shorter. In response to the travel time from the local location being shorter, control transfers to 1244; otherwise, in response to the travel time from the remote location being shorter, control transfers to 1260.

At 1244, control selects the local location as the second stop and the remote location as the first stop for the delivery mechanism. Control then continues at 1264 in FIG. 12C. At 1260, control selects the remote location as the second stop and the local location as the first stop. Control then continues at 1264.

At 1236, control determines whether the delivery of the remote order is time-sensitive. If so, control transfers to 1260; otherwise, control transfers to 1252.

In FIG. 12C, at 1264, control estimates a completion time of the local order. At 1268, control estimates a completion time of the remote order. At 1272, control determines which of the locations has been designated as the second stop. In response to the local location being designated as the second stop, control transfers to 1276; otherwise, in response to the remote location being designated as the second stop, control transfers to 1280.

At 1276, control sets the local completion time as the local estimate and continues at 1284. At 1284, control determines a travel delay from the remote location to the local location and continues at 1288. At 1288, control sets the remote estimate to be the sum of the remote completion time and the travel delay. Control then ends.

At 1280, control sets the remote completion time as the remote estimate and continues at 1292. At 1292, control determines a travel delay from the local location to the remote location and continues at 1296. At 1296, control sets the local estimate to be the sum of the local completion time and the travel delay. Control then ends.

FIG. 13 is another example implementation of a system according to the principles of the present disclosure, for use with a delivery service. The delivery service is described, simply for simplicity, in the context of a human driver driving an automobile. However, the disclosure is not so limited. The human driver may use other transportation mechanisms in addition to or distinct from an automobile. For example, the human driver may use public transit, bicycles, motorcycles, walking, etc.

Further, the human driver may be replaced for some or all of a delivery process by automated or self-driving equipment. For example, a flying or driving drone or other autonomous vehicle may convey an order for at least part of a delivery process. In various implementations, the delivery vehicle may incorporate components for preparation, production, and preservation of order items, such as food. For example, the delivery vehicle may incorporate hot and/or cold storage areas for some or all portions of an order. Further, a production environment may include a last-minute heater that will be activated just prior to final delivery. For example, when delivering a hamburger, a heating element may be activated just prior to arrival at the ultimate delivery destination to heat cheese on top of the hamburger. In various implementations, some or all preparation steps may be performed in the vehicle, such as bringing a frozen item up to room temperature, cooking a food item, etc.

In various implementations, if the delivery destination is an apartment, a robot may convey an order to the entrance of the corresponding apartment complex, while a human driver meets the robot and then hand carries the order to the door of the apartment. In other implementations, a robotic conveyance system using, for example, pneumatics may distribute the order to a second location where the order can be picked up by a human or autonomous delivery system for final delivery to the delivery destination.

In FIG. 13, control begins at 1304 in response to a delivery order being received. At 1304, control adds the local order to the order database as a new order. For example, this may be performed as described in FIG. 7. Control continues at 1308, where control estimates a completion time of the order based on its position in the queue in the order database. Control continues at 1312, where control communicates with one or more delivery services to determine a set of available delivery drivers (again, these are understood to be more broadly delivery mechanisms, whether or not relying on a human driving an automobile). Control determines travel times for the set of available delivery drivers from their current locations to the local location. In various implementations, control calculates these travel times based on current locations of the delivery drivers; in other implementations, some or all of the travel times may be calculated by and provided by the delivery service(s).

At 1316, control determines whether the estimated completion time is later than some threshold. If so, control transfers to 1320; otherwise, control transfers to 1324. The threshold may, in various implementations, be a median value of the travel times of the available delivery drivers. As a simple numeric example, consider a scenario where (i) the completion estimate for the order is 20 minutes from the current time and (ii) the set of available delivery drivers has a median travel time to the local location (for example, a restaurant preparing a food order) of 15 minutes. A delivery driver 10 minutes away would have to wait at the restaurant for 10 minutes until the food was ready. A delivery driver 20 minutes away could arrive at the restaurant when the food order completes; however, requesting a delivery driver 20 minutes away requires extra driving (wasting time and energy in the form of gasoline or electricity) when half the drivers are less than 15 minutes away.

At 1320, because the completion time is later than the current time plus the median travel time, control waits for a delay period. This delay period allows the order to get closer to completion so that a closer driver can be selected. The delay period may be chosen based on the median travel time—for example, as a percentage (such as 30%, 50%, or 70%) of the median travel time. Control then continues at 1328, where control updates the completion time estimate of the local order, which may be more accurate now that more time has passed. Control then continues at 1312 to obtain a new set of delivery drivers and their associated travel times. In various implementations, the optimization represented by 1316, 1320, and 1328 is omitted, as indicated in FIG. 13 by the dotted lines.

At 1324, control selects a delivery driver from the available set such that the driver will arrive as soon as possible following completion of the order. In other words, the selected delivery driver will have a corresponding travel time that is as little above the completion delay (the difference between the completion estimate and the current time) as possible. One way of achieving this selection is by subtracting, from the travel time for each delivery driver, the completion delay, and then choosing the delivery driver having the smallest positive travel time.

Control continues at 1332, where the order is assigned to the selected delivery driver. Control then ends. In various implementations, once the order is assigned to the selected delivery driver, operations similar to those shown in FIG. 11 may be performed, where delays in the selected delivery driver may attempt to be accounted for by delaying production of the order. Similarly, if the delivery driver will be unexpectedly early or an unexpected delay in the order has occurred, the operations of FIG. 11 to attempt to reprioritize the delivery order for earlier completion may be performed. This may include repurposing an already-in-process order or, if the delivery order is already in process, attempting to swap it with another in-process order that is closer to completion.

In various implementations, the delivery system may use one or more of a vehicle such as an automated guided vehicle (AGV) or autonomous mobile robot (AMR). For example, the first operator may be located in or adjacent to a fulfilment warehouse and the AGV/AMR may ferry completed orders from the first operator to another location in the fulfilment warehouse, for ultimate delivery to a customer and potentially for combining with other aspects of the order. For example only, the first operator may be a restaurant preparing food orders (such as fresh, ready-to-eat food orders) while other portions of the fulfilment warehouse prepare other goods, such as groceries or consumables.

Arrival time of a AGV/AMR to the first operator may be estimated or known precisely based on a schedule or defined path of the AGV/AMR. The first operator can therefore treat the arrival time of the AGV/AMR similarly to arrival times of other delivery services. In various implementations, a specific set of resources (such as AGV/AMRs or driven vehicles) may be assigned exclusively to the first operator such that the set of resources is known at any given moment in time. If the set of resources are traveling known paths with consistent travel times, the arrival times of delivery vehicles will be deterministic, allowing for more straightforward planning.

In various implementations, a single delivery vehicle (such as an AGV/AMR or a delivery driver) may pick up multiple orders in certain situations. For example, if the orders are going to the same ultimate or intermediate destination, the orders may be combined and delivered together by the same delivery vehicle. For example, orders going to the same address, or to different addresses within a single building, may be combined into a single delivery vehicle. Similarly, if multiple orders are going to a single intermediate destination, such as an aggregation point of a fulfillment center (where the orders may be combined with other orders for delivery), the orders may be provided to the same delivery vehicle.

Even if there is no single intermediate or ultimate destination, a single delivery vehicle may collect multiple orders and then deliver them to their respective destinations. This aggregation is most beneficial when one destination lies along the route to a second destination. The aggregation is efficient when the destinations are very close to each other—especially when the total distances among the destinations is a small percentage (such as less than 10%) of the distance from the first operator to the group of destinations.

When multiple orders can be picked up by a single delivery vehicle, the first operator may optimize completion of those multiple orders to be as close to immediately prior to arrival of the single delivery vehicle as possible. Further, if one or more orders going to a single destination will not be ready upon the arrival of the delivery vehicle, the first operator may choose to delay the departure of the delivery vehicle until those orders are complete—this may be especially helpful if the first operator knows or predicts that there will be a significant delay until the next delivery vehicle will arrive. The system may use a cost function to evaluate the possible options and select a solution having the least cost.

For example, cost may be measured based on the delay between completion of an order preparation and that order reaching its destination (either an intermediate destination or its ultimate destination). A delay-based metric may be of highest importance when the order is ready-to-eat food that may have hot components, cold components, or a combination. The cost may also be based on number of trips made by a set of delivery vehicles or by total travel distance or travel time of the set of delivery vehicles. The cost may also be based on whether other orders (such as orders being prepared for an alternative delivery scheme, such as customer pickup) will be delayed in order to align completion of delivery-service orders. Further, the cost may be based on how much variation will be produced in ultimate delivery time from an initial estimate. Faster ultimate delivery than estimated may be counted as a cost (though perhaps weighted less), even though faster delivery is generally less problematic compared to slower-than-expected delivery.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set—in other words, in some circumstances a “set” may have zero elements. The term “non-empty set” may be used to indicate exclusion of the empty set—in other words, a non-empty set will always have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1164-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A control system for a culinary instrument, the control system comprising:
an order management module configured to generate parameters for a user interface;
an order prioritization module configured to assign priorities to a set of orders in an order database based on a set of prioritization rules, wherein the assigned priorities establish a sequence of the set of orders;
an order wait time module configured to estimate wait times for the set of orders, wherein the order wait time module estimates wait times for each of the set of orders based on a current status of the culinary instrument and a model of predicted interruptions of the culinary instrument, wherein the order management module is configured to transform the user interface by modifying at least one of the parameters in response to the estimated wait times; and
an instrument control module configured to control the culinary instrument to prepare a food item specified by an order of the set of orders specified as next by the sequence.

2. The control system of claim 1, wherein the control system is configured to control a plurality of culinary instruments including the culinary instrument.

3. The control system of claim 2, wherein the instrument control module is configured to, in response to availability of a first instrument of the plurality of culinary instruments, selectively control the first instrument to prepare the food item specified by the next order.

4. The control system of claim 3, wherein the instrument control module is configured to, in response to availability of a first instrument of the plurality of culinary instruments:
identify ingredients necessary to prepare the food item specified by the next order;
identify in-stock ingredients present at the first instrument; and
in response to the necessary ingredients being a subset of the in-stock ingredients, control the first instrument to prepare the food item specified by the next order.

5. The control system of claim 1, wherein the instrument control module is configured to, in response to availability of the culinary instrument, control the culinary instrument to prepare the food item specified by the next order.

6. The control system of claim 5, wherein:
the culinary instrument includes a plurality of subsystems;
preparing the food item specified by the next order begins with an initial subsystem of the plurality of subsystems; and
availability of the culinary instrument is indicated by availability of the initial subsystem.

7. The control system of claim 6, wherein availability of the initial subsystem is indicated by a container of a food item for a prior order moving away from the initial subsystem.

8. The control system of claim 6, wherein availability of the initial subsystem is indicated by completion of work performed by the initial subsystem on a food item for a prior order.

9. The control system of claim 1, wherein:
transformation of the user interface includes displaying a time indicating at least one of the estimated wait time for the next order and an estimated completion time for the next order; and
the estimated completion time is based on a sum of a current time and the estimated wait time.

10. The control system of claim 1, wherein:
transformation of the user interface includes displaying a progress bar; and
a length of the progress bar increases monotonically as the estimated wait time for the next order decreases.

11. The control system of claim 1, wherein the order prioritization module is configured to determine the assigned priorities based on, for each order of the set of orders:
a timestamp indicating when the order was placed; and
a selective adjustment to the timestamp.

12. The control system of claim 11, wherein the order prioritization module is configured to determine the selective adjustment for each order of the set of orders by:
determining a set of rules applicable to the order; and
summing an adjustment value for each rule of the set of rules.

13. The control system of claim 12, wherein:
the set of rules is selected from a plurality of rules; and
each rule of the plurality of rules is associated with a respective adjustment value.

14. The control system of claim 12, wherein:
the set of rules is selected from a plurality of rules; and
each rule of the plurality of rules specifies one of a respective adjustment value and an expression to calculate the respective adjustment value.

15. The control system of claim 1, wherein the order wait time module is configured to estimate the wait times based on performance data for staff members associated with the culinary instrument.

16. The control system of claim 15, further comprising a data store configured to store performance data for each member of a plurality of staff members.

17. The control system of claim 16, wherein the order wait time module is configured to estimate the wait times based on performance data for ones of the staff members staff presently working.

18. The control system of claim 1, wherein the model of predicted interruptions of the culinary instrument outputs (i) a likelihood of interruption of the culinary instrument and (ii) an estimated length of the interruption.
